(19) United States
(12) Patent Application Publication
(10) Pub. No.: US 2019/0241053 A1
(43) Pub. Date: Aug. 8, 2019

(54) Open convertible hardtop for Jeep type SUV

(71) Applicant: Kanti Desai, Richardson, TX (US)

(72) Inventor: Kanti Desai, Richardson, TX (US)

(21) Appl. No.: 15/998,243

(22) Filed: Nov. 20, 2017

Related U.S. Application Data
(60) Provisional application No. 62/424,158, filed on Nov. 18, 2016.

(51) Int. Cl. B60J 7/14; B60J 1/18; B60J 1/00; B60J 1/14; B60J 7/185; E05F 15/611

(52) U.S. Cl. CPC B60J 7/141; B60J 1/1823; B60J 1/007; E05Y 2900/55; B60J 7/1851; E05F 15/611; B60J 1/1876; B60J 1/14

(57) ABSTRACT

A rigid Convertible Hardtop to secure Jeep type vehicle has opening window portions that provides freedom top in passenger area and this invention offer several ways to open at top, sides and rear windows to open manually or powered either to set above the top surface, behind the rear glass or insert inside to make open vehicle or sides and rear windows can be remove with additional options to make full manually open convertible hardtop above entire rear cargo area with modified safety roll cage pipes to close and open with Convertible hinge as designed to flip over the top cover to bottom side surface to insert top cover inside of rear cargo area will capable to close and open entire of the passenger area, sides, top and rear of the vehicle anyplace, anytime whenever user like to do for open air and clear view driving experience surrounding all sides and top area of the vehicle to enjoy pleasant weather condition open air pass through with clear vision on driving to make as inbuilt with conversion on existing hardtop or some of the options to make new one to install one time only instead of time and money wasting separately available these featured soft top covers in market with unnecessary expensive high cost which users replacing seasonally in the past 75 years with several hour time consuming and storage issues of removed hardtop plus installing substitute soft top with many hassle issues like unsafe, flapping noisy, air, wind noise and water leaking, unmatching body color, fad or color changing with blurry view see through vinyl window using for open air driving experience.

This invention is complete solution for recreation type vehicle users as two in one featured in Hardtop only for openable features offer as needed with secured leak proof conversion In hardtop with time saving anyplace anytime while travelling to open or closing features in few minutes with saving on never needed expensive openable soft top so users never need to remove complete hardtop from the Jeep types SUV vehicle as to make inbuilt with several options to modify or make in Hard top with rigid and best weather protection.

### BACKGROUND OF THE INVENTION

### 1. Field of Invention

This invention relates to the field of automobile vehicle like Jeep or similar kind of sport utility vehicles to utilize Hardtop as open window convertible hardtop in passenger area and all sides and rear windows of cargo area to open vehicle anywhere anytime for open air driving experience or close and cover up for protection of passenger and goods stored in cargo area from weather, stealers and give more safety to interior of the vehicle in rigid material as hardtop.

This Invention offers so many problems resolved for jeep type SUV users with openable Convertible Hardtop Cover to give complete rigid hardtop protection at anytime and anywhere to convert vehicle to open partially in passenger area only or complete vehicle open for open air and open view driving experience or closed for fully protection from weather and stealer as per it can be installed permanently above the vehicle,

where all side and rear windows open outside or inside of vehicle manually or with powered motor within few minutes to open or close position while parked.

This Invention offer vehicle can be converted to open or close position anytime in few minutes by only one person him/her self as per designed to less weight freedom panels at front and rear seating area as common to make rear cargo area with any one of out of 5 types of model with using any of following 5 options to make rear cargo area open and closed when needed.

This invention offers 5 options to choose anyone of from 5 of different options and as New 5th Option as to offer with new Utility function to open rear cargo area hardtop glass windows as per user's convenience to install and 3 of the optional model to male, factory installed safety roll cage pipes stay as is, so, manufacture can make with any one of option model with 5 different options. and it to making any model of option as curved shape at top edge, then manufacturer must have to use designed Hinge support above rear cargo area if hardtop is made as a curved shape designs at top skies or rear vertical edge corners.

Option 1 A

In rear cargo area both side windows and rear window can be opened from its bottom edge and connected with hinges at top edge with openable hardtop convertible frame. In this option, all 3 windows can be open with attached 270 degrees rotate hinges, which can be open and lifted from bottom edge and open outside rotated and set horizontally parallel above the top of rear cargo area hardtop surface. This option can be made automatic with powered motors and not required any changes on existing roil cage pipes comes with factory installed in Jeep type vehicle

Option 1 B

In this option side windows can be open and rotate behind rear of the vehicle plus in this option, has additional top window can be opened from its front side edge and connected with hinges at rear side edge with openable hardtop convertible frame.

In this option, all 3 windows can be set parallel in vertical position outside rotated and set behind the rear glass window of rear cargo area. This option can be made automatic with powered motors and not required any changes on existing roll cage pipes comes with factory installed in Jeep type vehicle. All windows must make clear or partially tinted through vision so when all side and top glass windows set behind rear glass window driver can see the rear image in rear view mirror while driving.

Option 2 A

In this 2^{nd} option as 2A, both side windows can be opened from its front edge and connected with hinges at top rear edge corner with openable hardtop convertible frame. In this option, both left and right-side windows can be insert inside manually by pushing and it hang with part #20 channel attached inside under surface of rear cargo area hardtop. Also, it has installed Part #20 Channel to support bottom edge corner of the both side windows to insert in properly with help of part #24 can be slide inside of Part #20 channel.

A little front edge will stay out at both left and right-side window frames with support of bottom edge of frame. In this option rear glass window frame is installed permanently above the rear door of the vehicle.

And Top window can be opened from its front edge and rotate downward inside and stay parallel with rear glass window, no any changes required on existing roll cage pipes comes with factory installed in vehicle.

Option 2B

In this 2^{nd} option as 2B, Additional drawing of FIG. 14 and FIG. 15 added as this 2^{nd}Option can be made only as on factory installed original hardtop covers rear side windows can be open and part #24 will slide in side of rear area with supportive channels part #20 at top and bottom side too. Part #97 additional designed extra vertical plate will be attached at rear vertical edge of the window frame so on closed position of the window it will press the weather strip to seal for weather protection, this option will offer both rear side windows to open at top of the rear cargo area no additional window shown to make economic model.

Option 2C

In this option as 2C to make the model, both side windows can be opened from its front edge and connected with hinges at top and bottom rear edge corner with openable hardtop convertible frame. In this option, both left and right-side windows can be open inside manually or by power motor from its front edge and rotate horizontally toward rear glass window and hang vertical each other parallel with rear glass window frame. For this option rear glass window frame is installed permanently above the rear door of the vehicle, but it can be kept as is from factory made as installed on rear wall of the rear cargo area.

Top window can be opened from its front edge and rotate downward inside and stay parallel with rear glass window and can be locked with latch at bottom edge.

In this option factory installed roll cage pipe need to be cut and remove from rear cargo area only. But additional metal angle support can be installed at inside rear corner and top side corners to give more safety for the goals stored in rear cargo area in case of rollover vehicle.

Option 2D

In this 2^{nd} Option as 2D. Both side windows can be opened from its bottom edge and connected with rivet hinges at top both corners of the glass and attached with c shaped channel inside of openable hardtop convertible frame. In this option both side windows can be opened and inserted inside in c shaped channel, set parallel and set horizontal above the factory installed top horizontal roll cage pipe. Rear glass window can be opened from its bottom edge and rotate inside toward up and locked with hanging knob from top surface to set horizontal parallel with top surface or latch lock can be install with top horizontal roll cage pipe.

In this option, no any changes required on existing factory installed roll cage pipe comes with vehicle in rear cargo area

Option 2 E

In this option as 2E to make rear cargo area side windows to open and insert in side of the rear cargo area, I shape hinges will be attached at the top edge of the side and rear windows. So, with these hinges attached side windows can be open outside and windows can be inserted inside with I shape shaft can be slide in downside open C channels under the top of the rear cargo area top cover.

Option 2 F

In this 2^{nd} option as 2F model to make both side windows can be open out side with 270 degrees rotation hinges and it can be set above the top surface of the rear cargo area top cover, and rear window can be open after lifting from its bottom edge about 90 degrees to make horizontal and it can be insert inside of the rear cargo area top cover with help of supportive C channel both sides inside of the rear cargo area. Of the solid metal ball point hinge which be slide in center towards front

So in with installed any one of this model of this invention, user do not need to install or remove current available hardtop and replace soft top cover above vehicle for open air driving experience or close for protect ion which took hours to do replacement of hardtop and soft top both ty pes of current available covers.

Option 3A

In this option as 3A, This is additional designed hinge support required as option 3A to make hinge exactly fit and give solid support to the hinge above curved surface of rear cargo area top cover if Option 1, or any option model has rear cargo area top horizontal corner of sides and rear and rear edge vertical corner is designed to made curved shape to decrease aerodynamic force and better look at top side edge and rear top corners edge or rear corner vertical edge of rear cargo area hardtop cover.

Option 3B

In this option, both left and right-side windows of rear cargo area hardtop can be open from its bottom edge with lifting and rotate to upside with support of hinges attached with hinges installed at top side edges as shown in FIG. 35 and FIG. 36. but Hinge support part #51 needed if top corner edges are curved shaped and set above the top surface of the rear cargo area hardtop which is not shown in this figure.

Both side windows can be locked with rotate latch installed above the top surface of the hardtop, so it stays fixed while driving in high speed and does not make rattling sound as part #63 rubber cushion will be pressed between two surface of side window frame and top surface to the hardtop cover

but in this option rear glass window can be open inside from lifting its bottom edge and rotate with attached inside hinges towards up and set horizontally parallel with top surface of hardtop and it can be locked with 2 latches installed under rear cargo area top horizontal roll cage pipe. so, it can be stay locked while driving the vehicle.

Option 3C

As in this option 3C if rear glass-window open inside as rotate from bottom to top will be problem if rear cargo area is loaded with large size goods, then as shown in FIG. 40,41 and 42 is another option to open rear glass window open outside with rotation of bottom to upward to make glass as horizontal position and then it can be slide in with C shape channel at both side ends and in center at top edge of the glass, ball point hinge will be slide inside of down side open hanging C shaped channel, so as per more length of rear window glass it will get strong holding support in center for top edge of the glass, and part #70 F lock will give support to the bottom edge of the glass when it's at opened position, with this slide in rear glass window inside of rear cargo area as additional option will avoid any of the rattling noise or scratches issues as of setting both side windows above the top and rear glass window as opened and slides inside of rear cargo area, so, none of the windows will touch with each other's.

Option 3 D

As to make 3^{rd} option as 3D, rear glass window open to completely remove in this option as shown in FIG. 40,41 and 42, to avoid all 3 windows gather parallel at one surface and make rattling noise.

so, both side windows can be opened and set above the top surface of the rear cargo hardtop and rear glass window can be open with rotation to upside in horizontal position and its right-side end shaft as its designed can be pull out up side from upside opened C shape hinge opening and then lift upward so entire glass window assembly can be slide right side above C shape hinge and pull out left side shaft inserted from fixed hinge cylinder and remove the complete rear glass assembly and it can be stored inside floor or rear cargo area.

Option 3E

In this option as 3E, if both left and right side and rear windows want to remove completely as like shown in FIG. 43 with shown removable hinge images for rear glass window in FIG. 44,45 and 46 for both side to remove the attached rear glass window from the frame to choose which types of the removable on either sides or on rear window as shown in FIG. 43

2 different types of the removable hinges shown in FIG. 47 and 48 and in FIG. 49 and 50

,then as shown in FIG. 47 and 48 part #55 side window frame has 2 part #91 extended plate installed above the top edge which can be inserted inside of part #90 holding slot which is installed at top edge of the rear cargo area hardtop frame as shown in FIG. 45 side window frame is fixed on frame of hardtop cover below the edge of window frame part #10 weather strip will be pressed to give weather protection when it's at closed position, so when if need to open, 2 screws need to be removed from the inside at bottom edge of side window frame which is fixed with factory made top surface threaded through holes, so bottom edge can be lift up outside and complete window frame can be pulled downside so part #91 extended plate will come out from both holding slot and window will be removed completely to store in rear cargo area. That is make side window frame open for open air driving experience.

FIG. 48 is an enlarged sketch of part #91 and part #90.

Or to choose another type of removable hinges as shown in FIG. 49 For, if both left and right-side windows want to remove completely, then as shown in FIG. 49 and 50. part #55 side window frame has part #93 right cylinder hinge installed above the top surface at side top corner of the hardtop cover which can be slide with rotation of attached assembly lock handle, this cylinder hinge pipe will hold part #91 hinge shaft which is installed at top right corner of part #55 window frame when side window frame need to at closed position, if side window frame need to be remove from the hardtop cover frame than part #93 assembly handle can be rotate to slide cylinder hinge cover toward right so top corner hinge shaft will be open. then this right corner can be pull out little from the hardtop frame so complete frame can be pull right side to release fixed hinge shaft at left top edge corner above window frame. once complete frame will remove it can be store on floor of rear cargo area hardtop for open air driving experience.

if side window frame part #55 is fixed on frame of hardtop cover, window frame will press part #10 weather strip to give weather protection when it's at closed position, so when if need to open, 2 screws need to be removed from the inside at bottom edge of side window frame which is fixed with factory made top surface threaded through holes, so bottom edge can be lift up outside and complete window frame can be pulled downside so part #91 extended plate will come out from both holding slot and window will be removed completely to store in rear cargo area. That is make side window frame open for open air driving experience.

FIG. 50 is an enlarged sketch of part #92 and part #93

Option 3F

In Option 3F is an additional clear vision soft top cover designed to make PVC type clear vision material has front and rear side locking slots to install above the front and rear passenger area with sides has weather strips for air tight sealing to protect for wind noise or water leak as shown in FIG. 51 and 52

Option 4 A

Option 4A as shown in FIG. 54,55 and 56 is a combination of selection on above mentioned options 1,2 and 3 to make Open convertible windows of rear cargo area hardtop when manufactured new or on existing factory-made hardtop if it is as curved shape at top horizontal at sides and at rear and user choose to open either side windows or rear glass windows in which side windows can foe open and rotate upwards with 270 degrees rotation manually or by right angle power motor as shown in this figure or same this model has removable hinges on side windows has removable slot in rotation plate at rear end so if user select to remove the windows form the vehicle too as next option 4B

This is a similar option as mentioned with new clear drawing attached for clarity on those option 1,2 and 3 to select which features users like to be installed if top horizontal corner is in curved shape. FIG. 54 is complete closed Jeep type SUV with its part #3 and #4 Freedom panels is at closed position and both left and right-side windows is as closed position and rear glass window also shown as closed position with vertical rear edge of the both side windows has vertical extension of plate part #10 with weather strip to get pressure on weather strip when windows are at closed position, plus additional plate support is installed at inside edge of top of the both side windows when both side window will be at closed position, also Part #22 weather strip is installed at bottom edge of the rear glass windows as shown in FIG. 56. As shown in FIG. 54 both side windows are attached with removable hinges in 2 parts as mention with Part #98 fixed hinge portion which can be installed permanently with rear cargo area hardtop cover frame above the part #51 Hinge support below all side windows as top horizontal edge is in curved shapes. Part #99 removable hinge portion is attached permanently with both side window frames at top edge surface with screws.

This hinge is specially designed as if users want to open She side windows and set above the hardtop cover either manually or with help of part #95 Power motor to set above the hardtop cover while driving the vehicle so, no required to store and keep safe inside of rear cargo area or to store in garage.

Similar-way Part #98 fixed hinges are attached with rear cargo area at bottom edge of the opening frame above top edge of the rear glass window. Part #99 removable hinge portion is attached with rear glass window at top edge and shown as ail side window and rear glass window removable hinges are inserted above the shaft of the part #98 fixed hinge. If user want to remove the rear glass window, then it need to be opened upwards from its bottom edge and rotate up to 150 degrees till locking knob of the part #99 is open to slide out to the right side. So, it can be removed from the shaft of part #98

Both removed freedom top panels not shown in the opened vehicle image

Option 4B

In this Option 4B, as shown in FIG. 64, 65,66 and 67. If some of the user do not want to set side windows after its opened above the hardtop cover and want to remove it completely then it can be remove once it opened as lifted from bottom edge of the side window and lifted upwards till it's release knob comes up as open to slide out to remove the window. Part #96-cylinder hole is designed as it can be removed from the shaft of the part #95 power motor. And it can be stored on the floor of the rear cargo area to feel open air driving experience

Similar way Part #98 fixed hinges are attached with rear cargo area at bottom edge of the opening frame above top edge of the rear glass window. Part #99 removable hinge portion is attached with rear glass window at top edge and shown as all side window and rear glass window removable hinges are inserted above the shaft of the part #98 fixed hinge. If user want to remove the rear glass window, then it need to be opened upwards from its bottom edge and rotate up to 150 degrees till locking knob of the part #99 is open to slide out to the right side. So, it can be removed from the shaft of part #98

Part #95 Right angled power motor is installed at both rear top edge corner of the hardtop cover and it is attached with motor shaft with Part #96 vertical plate with both side windows at rear vertical edge surface to rotate window with power motor toward upside of top surface with 270 degrees rotation.

Both removed freedom top panels not shown in the opened vehicle image

Option 5

In this Option 5 is to make as new designed totally different new concept instead of opening only sides and rear windows, Entire rear cargo area can be open, left and can be inserted above the floor of rear cargo area to set after opening with vertical 90 degrees rotation from right side to up, then rotate exact 180 degrees to flip over its top surface to downside then it can be inserted in rear cargo area floor with 90 degrees vertical rotation as opened rear cargo area from top closed position.

This-amendment can be considered to issue new priority date as its filed with Non-Provisional application.

FIG. 53 is additionally designed adjustable support to install at many places where need support for top cover, so it can be install above part #15 roll cage pipe to give holding and support to the top surface of the hardtop cover

### 2. Description of the Related Art

There are some known vehicle hard tops are with the ability to take the whole roof sections off and storing them in your garage or other building. When the roof sections and rear cargo area hardtop cover are stored in garage or other building, which will not with vehicle during a trip in case it rains or top need to be placed to close the vehicle for all protection. Soft tops are easier to store in a vehicle and generally can be open and close. Soft tops have disadvantages such as, flapping, wind noise, tearing etc. and less secure vehicle locking. A hard top is needed with the same advantages of a soft top and none of these disadvantages. In the known tops, when you remove the top, there is no safe place to store anything inside the vehicle. There is many known original manufacturer or aftermarket hardtop covers are available to install above the Jeep type vehicle. Some of has only just front seat area to open top sunroof to enjoy open air ride option. But rest of the top area and cargo area side windows and rear window is stay closed all the time when those top covers are installed on the vehicle. So, to enjoy open air ride user must remove it complete roof and store this very big size hardtop cover in garage or safe place where its hold lots of space too.

Some of the vehicle users install and use permanently or seasonally soft top covers which available in aftermarket to install above the vehicle for occasionally they can open or close as per requirements of open air driving or close when vehicle not in use with soft top cover either on top or both of the sides at rear cargo area with zipper to open or close position when vehicle is not occupied so it gives some protection of dust or rain to the interior of the vehicle.

but soft top has so many disadvantages are like flapping, noise, dust, air, water leak, soft to cut, no clear vision at side and rear windows and not safe like hardtop in rollover or everywhere for passenger or goods inside the vehicle.

U.S. Pat. No. 5,009,465, issued Apr. 23. 1991, issued to Iuduni, et al., describes an automobile roof covering for a T-type top which can be rolled for storage.

U.S. Pat. No. 6,851,739 B2. Issued Nov. 30, 1999, to. Michael E. Hillard, Louis D. DeLellis, William A. Grabowski. Stephen K. Tebbutt, Describe Hard top convertible for jeep-type utility vehicle

U.S. Pat. No. 2,0150,130213 A1, issued to William H. Haberkamp, George Stickles, Magna International as Composite soft top assembly for SUV, both 2 and 4 door describes combination of soft and hardtop as soft top windows can be remove from the frame has hard glass in soft top frame and rear glass can be remove from the soft top cover frame only.

U.S. Pat. No. 5,738,405, issued Apr. 14, 1991, to Righters et al, describes a hardtop roof structure which can be manually dismantled into individual parts including a lamellar roof, a lowerable rear window, removable side windows, and a supporting frame for the roof structure. A soft top may be substituted for the hard top in the system. The hard top must be removed to allow mounting of the soft top in the top feme system.

U.S. Pat. No. 5,803,529, issued Sep. 8, 1998, to Perry-Bores et al describes a system for removably covering the rear portion of a Jeep-type vehicle with a soft top.

U.S. Pat. No. 5.992,917, issued Nov. 30, 1999, to Hilliard et al., describes a system having a soft top and a removable hard top for a Jeep-type vehicle. The hard top must be removed before raising the soft top.

U.S. Pat. No. 4,8842,326, issued un. 27, 1989, to DiVito, R., describes motor vehicles with interchangeable body modules, including a hardtop models.

None of the above inventions and patents, taken either singly or in combination, is seen to describe the instant invention as claimed. Thus a hard top and Open convertible top for Jeep-type vehicles solving the aforementioned problems is desired to make solid rigid material Bard top cover with secure open and closing Hardware hinges and proper weather strip installation to secure from rain water, air leak or wind noise.

Present Invention is all in one substitute of both hardtop and soft top as a convertible combination feature. In Hardtop, this invention offers some of common options for front and rear passenger area Targa top, or its known as freedom panel top removal and can be leave opened or one of additional soft top option for clear view at top and protection for rain and noise in passenger area.

and 9 another different option to select one only model to make inbuilt installed permanently above the rear cargo area of vehicle to utilize open air driving experience anywhere and anytime with vehicle to opened for open air driving experience or close to secure from weather and stealer with solid rigid material of the hardtop.

### SUMMARY OF THE INVENTION

Present invention is resolving so many problems of Jeep Type Spots Utility Vehicle users to utilize and offer Open Convertible Hardtop cover. And give full protection of hardtop cover without removing from the vehicle and as per invention offer can be open at top in passenger area and both side windows and rear windows with optional extra top window on rear cargo area to open to make complete vehicle open at top and sides. So, users do not need to buy and install soft top cover for open air driving experience.

Jeep or similar kind of SUV is a very big size vehicle. So, few collapsible flexible material soft top is only possible to offer open air ride convertible options on vehicle. But automatic convertible soft top cover is costly due to its automatic mechanism is very high (almost 3 times high) price than hardtop in market and still it is soft top cover so it has same disadvantages are as following in detailed description.

Present Invention is giving complete vehicle open air driving enjoyment and view to all passengers at both front and rear seating area at top and both rear sides glass and top or rear glass of rear cargo cover of vehicle inbuilt and installed permanently can be open or close and rest of its assembly parts permanently stay above vehicle to close or open anytime and anywhere.

Present Invention give openable convertible hardtop frame structure with 5 options to select anyone of the selection of out of 5 options open and close without removing from the vehicle and eliminate hassle of removing hardtop and spend cost and installation time of soft top, for open air driving experience with full hardtop protection.

New updated 5^{th} option will be applicable with new priority date with this Non-Provisional application on date it will be applied.

So, to make maximum opening of the Vehicle requirement this Convertible option on rear cargo area is only can be install in rear cargo area when Part #15 roll cage pipe will be removed, and it is supported by extension to the sides behind the rear seats from the existing Jeep type SUV as it is required for safety in case of the rollover.

This 5^{th} option of the invention offers ail from and rear seating area passengers with 100% safety as roll cage pipes is removed only in rear cargo area to make fully convertible option to open entire top, side and rear walls to open and insert inside of rear cargo area with inbuilt mechanism to open and close the vehicle with hardtop anytime and at anyplace when it required to open or secure.

with additional option of partially clear soft top cover for passenger area for clear view or semitransparent view with protection from wind noise, air, dust, stealer and rain water

### BRIEF DESCRIPTION OF IMF SEVERAL VIEWS OF THE DRAWINGS

FIG. 1 is a perspective view with 1^{st} option to open windows in rear cargo area of the vehicle, showing the present invention is installed above the vehicle and showing entire vehicle is closed with freedom panel at front and rear seating area at top side and closed left (driver) side window in rear cargo area and rear window at rear is closed, and shown right (passenger) side window is opened and rotated above the top surface of rear cargo area.

FIG. 2 is a perspective view, showing the present invention is opened at front and rear seating area at top of the vehicle and removed both left and right seating area freedom panels and both side windows and rear window is opened, rotated and set above the top of the rear cargo area hard top at top outside of the vehicle.

FIG. 3 is a perspective view of the part #3 left side freedom panel is separated from the top of the vehicle. it has a part #18 a rubber channel is installed at front side edge to seal with front windshield frame for protection of water leak to inside of the vehicle. It has a pulling knob latch under bottom to fix and pull tight lock latch to seal front side windshield frame of the vehicle

FIG. 4 is a perspective view of the part #4 right side freedom panels is separated from the top of the vehicle. If has a part #18 a rubber channel is installed at front side edge to seal with front windshield frame to protect water leak inside of the vehicle.

It has pulling knob latch under bottom to fix and pull tight lock latch to seal front side windshield frame of the vehicle.

Part #19 a rubber channel is installed above top side bottom edge slot toward

Left (driver) side to seal bottom surface of the part #3 Left side freedom panel right side slot for water leak protection to inside of the vehicle.

FIG. 5 Shows a perspective view of the present invention has part #6 is an openable Hardtop cover can be installed above rear cargo area installed permanently. It can be installed above top edge of both side of the rear cargo area of the existing Jeep type of vehicle.

The top horizontal frame has a slot to give support and tightening through hole from inside to hold part #3 and part #4 left sides and right freedom panel respectively.

front top surface slot above this hardtop Part #18 a rubber sealing channel is installed above the top side bottom slot where freedom panels end rest and tighten with screws to seal both bottom of the part #3 and part #4 left and right side freedom panels respectively to protect water leakage inside of the vehicle

Part #5 has horizontal slot at bottom rear end corner for water drainage to protect rain water enter between vertical rear end edge of both freedom panels at top of the vehicle.

Above the top edge of openable hardtop cover one slot is for holding additional part #26 soft top cover to insert part #28 to tight soft top when both freedom panels above both passenger area not installed above the top of the vehicle for clear view driving experience.

Part #7 Left (driver) side window with frame relates to part #9 short hinges which installed above left top edge of hardtop and shown as closed window at left side of the vehicle.

Part #7 right side glass window with frame relates to part #9 short hinges which installed above right top edge of hardtop and shown as opened window from right side of the vehicle and rotated and placed above hardtop cover on right side top of the vehicle.

Part #8 is rubber sealing part installed at inside edge of both side window frame of openable hardtop

Part #11 rear glass window relates to Part #13 tall hinges above the rear top edge of hardtop and shown as closed at rear window of the vehicle. part #12 rubber sealing part installed at inside edge at rear window frame of hardtop

FIG. 6 is a perspective view with option 1 to make rear cargo area hardtop in which top and side windows can be open outside and can be set behind the rear glass window vertically parallel showing the present invention is installed above the vehicle and showing entire vehicle is closed with freedom panel at front and rear seating area at top side and also closed left (driver) side and right, (passenger) side window and this option has additional top window above the openable hardtop cover is shown closed

and rear window at rear is also shown as closed.

FIG. 7 is a perspective view, showing the present intention of snaking option 1 to make rear cargo area hardtops and is opened at front and rear seating area at top of the vehicle and removed both left and right freedom panels and part #37 both left and right-side windows is opened outside from its front edge towards rear and rotated horizontally about 270 degrees and set behind rear window.

Top window is opened outside from its front edge after released from its rotate latch lock.

and rotated about 270 degrees towards back and set parallel behind rear glass window.

Rear glass window will stay closed while rest of three window is hanging behind rear as opened and rotated behind the rear glass and set on back of the openable hardtop cover frame.

FIG. 8 is enlarged view of left side window is attached with Part #41 small hinges are installed at rear left edge of the openable hardtop frame of the rear cargo area

FIG. 9 is enlarged view of part #41 long hinges installed above the top rear edge of the openable hardtop frame of the rear cargo area with rear edge of the top glass window

Window can be open from its front edge outside, rotate towards back and can be set behind rear glass window parallel behind if both side glass window also opened.

FIG. 10 is Enlarge view of rotating locks can be installed at front and can be installed on rest of the edges of the glass windows for pressure lock as per it has rising slop at it inside surface as it rotates it give pressure on glass windows to tight with rubber sealing installed on window frame for weather protection.

FIG. 11 Showing vehicle can be made with 2nd option to open windows in rear cargo area and can be insert inside of vehicle and additional feature at top of hardtop has a glass window can be open inside and hang with hinges downward vertically parallel with rear glass inside of vehicle

In FIG. 11 vehicle is showing closed at front and rear seating area with part #3 left and part #4 right side freedom panels at top and rear cargo area hardtop is closed with left and right side glasses. Part #20 hanging channel is inside of vehicle at top side to support and hold both part #14 left and right side both window with glasses when its opened and inserted inside the vehicle.

At top of hardtop it is showing closed with part #21 top window with additional option of open inside the vehicle and closed at top surface of the hardtop. Part #17 Rear glass window frame is permanently fixed above the rear door and shown complete door with frame is opened.

FIG. 12 showing vehicle is opened at front and rear seating area at top of the vehicle and removed both left and right side freedom panels and it can be stored on floor of rear cargo area.

At hardtop above rear cargo area. Part #14 both left and right-side window glasses are opened outside from its front edge with released alter pulled latches and rotated outside to back at 90 degrees rear side of the vehicle.

As per it is fastened by Part #24 sliding knob at top rear edge corner and Part #25 Holder at bottom rear edge corner of glasses. once it both of left and right-side window glasses are opened it can go inside after manually pushing with hanging part #24 sliding knob through Part #20 a hanging channel is hanging from top of hardtop inside both sides of hardtop window frames and front edge of the glass ends will stay a little out at rear edge of both side of window frames. so in opened position both rear glass will hang under support channel is showing hanging inside of rear cargo area. Part #8 a rubber channel is installed at inside edge of both side window frames of the hardtop for weather protection.

Part #21 top glass at top of hardtop it is showing opened from top of the hardtop and it hang with support of hinges installed at inside top surface of hardtop by opened from its front side edge released from top window frame of the hardtop and hang ahead of 2 side glasses showing in rear cargo area of as in FIG. 12. Rear glass installed door with frame is showing opened.

In FIG. 13 shown in enlarged image of hardtop cover at front top edge slot is opened, both side glasses are opened and hanging inside of the rear cargo area in part #20 hanging support channel with part #24 sliding knob at top corner of rear edge of the glass and part #25 is holding knob installed at bottom corner at rear edge of the glass at bottom to enclose glasses when windows need to be close at sides of the hardtop.

Left and right side glass windows is hanging with sliding knob inside with Part #20 a hanging support channel installed under top of hardtop inside and its ends at both hardtop window frames. both side glasses hang little out at rear edge of both side of window frames. so in opened position both rear glass will hang under support channel is showing hanging inside of rear cargo area. Part #8 a rubber channel is shown installed at inside edge of both side window frames of the hardtop for weather protection when glass windows closed at both sides.

And top glass is opened and hanging inside of rear cargo area and hanging ahead of both side glasses. Both side glasses and top glasses are clear. So, each of is showing clearly as through clear vision. Part #8 rubber channel is showing at inside edge of topside frame of hardtop.

FIG. 14 showing as to make 2nd option as shown part #3 and #4 freedom panels is removed from the top and both side windows shown as opened from front to rear side and slide inside and it has additional support at the bottom edge corner same as top part #24 sliding knob which can be slide inside the part #20 bottom channel which needed to be set back and front as per the length of both side windows on existing jeep type vehicle, in this figure no, additional top window shown as installed for clarity of the drawings to explain. Part #97 vertical support is attached with inside edge of both side window's rear vertical edge to close tight with weather strips for weather protection. Part #12 weather-strip is also installed at top inside edge of rear cargo area hardtop frame.

FIG. 15 is an enlarged image showing only how the one of the side window is hold by top and bottom side with part #20 channel with part #24 both top and bottom ends, so it will not tilt or rattle while driving the vehicle and will not touch any surface of the other side window.

FIG. 16 showing 2nd option to make with open side windows can be open automatic with motor or manually inside with horizontal rotation towards rear glass shown as opened and rotated towards rear glass and both side glasses are set ahead of rear glass vertically parallel

This feature only can be installed if Part #15 roll cage pipe is not in rear cargo area or it need to be cut behind rear seating area add vertical and horizontal at top supportive pipe above rear seat for safety and removed behind rear seating area to end of rear cargo area.

Angle of metal or pipe can be install at rear end both rear corner vertical and one horizontal connecting with factory installed roll cage pipes running through toward front of the vehicle this additional pipe or angle can be very near inside of hardtop cover at rear end corner vertically and at top edge below hardtop cover for safety of rear cargo area in case of rollover the vehicle, so this pipe will not be on the way for both side windows to open and rotate towards rear glass window.

FIG. 17 showing enlarged image of left side glass window is opened from its front edge inside after rotation and it's both top and bottom corner part #30 hinges stay at left rear side corner of the window frame and part #15 replaced metal roll cage pipe or angle is shown inside at side and rear vertical and horizontal corners as additional safety for rear cargo area.

FIG. 18 showing prospective view showing the present invention to make as 2nd option of openable windows installed above the vehicle and showing entire vehicle is closed with freedom panel at front and rear seating area at top side and closed left (driver) side and right (passenger) side windows and rear window closed at rear cargo area

FIG. 19 is a perspective view, showing the present invention is opened at front and rear seating area at top of the vehicle and removed both left and right seating area freedom panels and both side windows is opened and inserted inside in support channel under the to, this option will offer both rear side windows to open at top of the rear cargo area no additional window shown to make economic model top of the rear cargo area and rear window is opened inside rotated upward and locked by holding lock installed with hard top at top of the vehicle.

FIG. 20 Shows a perspective enlarged view of the present invention has part #6 is an openable window hardtop cover frame installed above rear cargo area and installed permanently. It is installed above top edge of both side of the rear cargo area of the existing Jeep type vehicle. The top horizontal frame at front has a slot to give support and tightening through hole from inside to hold part #3 and part #4 left sides and right freedom panel respectively. front top surface slot above this hardtop Part #18 a rubber sealing channel is installed above the top side above bottom slot where freedom panels end rest and tighten with screws to seal both bottom of the part #3 and part #4 left and right-side freedom panels respectively to protect water leakage inside of the vehicle. Part #6 has horizontal slot at bottom rear end corner for water drainage to protect rain water enter between vertical rear end edge of both freedom panels at top of the vehicle.

Above the top edge of openable hardtop cover one slot is for holding additional part #26 soft top cover to insert part #28 to tight soft top when both freedom panels above both passenger area not installed above the top of the vehicle for clear view driving experience.

Part #32 Left (driver) side window with frame relates to part #16 rivet hinges at top corners which installed above top front and rear edge of glass window.

in FIG. 20 prospective view window glass shown as opened upward outside about 90 degrees from its bottom edge so made in horizontal position and inserted half only in Part #35 C shape channel so glass window is shown half portion is hanging out at left side of the vehicle.

Part #35 c shaped channel has horizontal slot on front and rear wall to insert and hold Part #16 rivet hinges toward front and rear.

Part #32 Right (passenger) side glass window with frame relates to part #16 rivet hinges which installed above tight top front and rear edge of glass and shown as opened window from right side of the vehicle and completely inserted inside part #35 c shaped channel placed under hardtop cover on right side of the vehicle.

Part 12 is rubber sealing part installed at inside edge of both side window frame of open window hardtop for weather protection.

Part #11 rear glass window relates to Part #30 hinges above the top edge of rear glass window at inside and fixed with inside edge of hardtop frame and glass window shown as opened at rear window frame of the vehicle opened inside upward lifted from its bottom edge and made parallel under right side glass window and locked with part #33 holding lock which installed under top surface inside of rear cargo area.

part #12 rubber sealing part installed at inside edge at both sides and top edge of openable hardtop frame for weather protection.

Part #34 rubber sealing part is installed at bottom edge of rear glass window for weather protection. It sealed tight with top inside edge of rear door when door closed.

FIG. 21 Showing perspective enlarged view of only openable rear hardtop frame structure

Both left and right side windows shown as open position and both glasses are completely inserted in Part #35 c shaped channel. Rear glass window shown opened inside and locked by holding lock hanging from top of openable hardtop frame.

Also, shown Part #18 rubber sealing part is installed above bottom slot at front throughout left to right for weather protection when part #3 and #4 left and right freedom panels are installed above the top.

vehicle has open window option to insert inside of vehicle in c shaped channel and additional feature is rear glass window can open inside and locked inside of vehicle and hang with holding lock.

FIG. 22 is showing perspective enlarged view of only part #32 left window is at closed position above the openable hardtop cover frame. Part #16 Rivet hinge is installed inside slot end of part #35 c shaped channel at both front and rear side top corners at left side of the vehicle. in FIG. 22 it is shown only left side inside the rear cargo area.

C shaped channel installed both front and rear side throughout to the right-side window

And it has countersink holes at top surface from inside to fix screws upside with under surface of openable hardtop cover frame.

FIG. 23 is showing perspective view of left side window frame of openable hardtop frame glass window is opened upward and inserted completely in part #35 c shaped channel with showing its bottom edge at top of the window frame, it's rivet hinges are in middle of the c shape channel.

Part #9 rubber sealing part is showing above the frame for weather protection.

FIG. 24 is enlarged view of top left corner of the left side glass window. Part #16 rivet hinge is showing installed with screws above top left corner of the glass window as shown in drawing. Also, installed on front edge top corner for hold the glass at front side.

FIG. 25 is showing only Part #35 c shape channel installed under the roof of openable hardtop cover frame front channel is open towards rear and rear c shape channel is open towards front.

It has long slot to pass rivet hinge through it

it is in C shape and its top surface has some countersink holes to fix screws under the roof of openable hardtop cover frame.

Bottom surface is only beginning after surface of glass touch inside at both Left and right side end. so, in beginning at both ends c shape channel is inverse L shape to make glass vertical when it is closed above the outside frame of hardtop

Bottom surface is to hold the left and right side glass when vehicle is opened at side windows of the frame and inserted inside parallel to top surface roof.

So, top surface is to fix the channel with top surface of hardtop

Front and back vertical surface has slot for pass through rivet and hold the rivet

And bottom surface of c channel is to support the glass when openable hardtop window is opened and glass is inserted in it

FIG. 26 is showing enlarged image of rear top edge corner of glass window as closed position at left side of the open hardtop cover frame. Rivet hinge is inserted in slot of vertical wall at both front and rear side of part #35 c shaped channel.

FIG. 27 is showing enlarged image of rear glass window and it top right-side edge has Part #30 hinges installed from inside wall of the glass. Hinges are attached inside at downside edge window frame of openable hardtop cover frame. So, it can be open inside of rear cargo area. Glass is shown as closed position on frame.

FIG. 28 is showing Option 2 to make as shown left side window is closed above the frame.

Side glass window frame is attached with Part #81 I shape hinge shaft at top side edge corner of hardtop

part #81 I shaped hinge shaft is above the top corner and its other end is attached inside of part #80 upside open C shape channel installed inside of top surface of the rear cargo area hardtop cover.

there is part #63 rubber cushion installed above the top surface of hardtop where both side windows can be set above it.

FIG. 29 is showing enlarged sketch of left side window frame is attached with Part #81 and another end of I shape Part #81 is inside of Part #80 Upside open C Shape channel.

this I shape hinge shaft has both ends as perpendicular as circular shaft so when glass window frame will be opened from frame of hardtop its can be lift little up above the upside open C shape channel so complete side window frame can be slide above the surface of the hardtop cover.

if roof rack is installed above the top surface than this open and slide above surface of the hardtop option can be use.

FIG. 30 is showing option 2 as complete rear cargo area both left and right-side window frames are opened and slides above the top surface of the rear cargo area hardtop and its locked by part #85 latch lock to hold side window frame as fixed and it has part #63 rubber cushion between window frame and hardtop cover, so it will not make rattling sound.

Rear glass window part #11 is shown as open and inserted inside of rear cargo area through its both side end in c shaped channel and hold by its extended C shaped frame inside and its top center edge ball point hinge is slides inside in downside open C shape channel. bottom edge of rear glass window is locked by part #70 F shape lock is rotated down and its half top F portion is rotated inside of cargo area, so bottom edge of glass window is in gap of F shaped knob will stay fixed and center of top edge of glass will hold by downside open C shape channel inside of rear cargo area so cannot make rattling sounds while driving the vehicle.

FIG. 31 Showing as to make 3^{rd} option to make as left driver side of the rear cargo area has additional designed part #51 hinge support required to make hinge exactly fit and give solid support to the hinge above curved surface of part #6 rear cargo area, top cover if Option 1, Option 2 and this Option 3 or any model has rear cargo area top corner is designed to make curved shape for aerodynamic force decrease and better look at top side edge and rear top corners edge of rear cargo area hardtop cover commonly current available models are look like in this FIG. 31 is top corner edge where vertical and horizontal surface meet at top corner is made curved shape so to install part #50 Hinge for side and rear glass windows to open or close is with solid support additionally designed part #51 curved support has bottom surface is required to make similar curved shape of aluminum or wood type solid material to install surface to surface with top edge curved shape of hardtop cover. This curved shape support has top surface and side surface is flat surface so its top and side surface make right angle to support hinge. Curved support has V shaped countersink at surface and through holes through which long bolt can pass through and those bolts inserted in trough holes of curves shape corner of hardtop cover and tightened with bolt from inside surface of hardtop cover to make solid support to install hinges. Part #50 hinges have some extra holes to pass screws to insert in solid curved support and some holes goes direct inside of rear cargo area hardtop cover at the end portion of hinges. And at other end of hinge towards downside end bolts are installed with side glass frame.

FIG. 32 Showing rear view of one side of the rear cargo area has additional designed Part #51 hinge support required to make hinge exactly fit and give solid support to the hinge above curved surface of part #6 rear cargo area top cover if Option 1, Option 2 and this option 3 any model has vertical side end or any model has rear cargo area top and rear end corner is designed to make curved shape for aerodynamic force decrease and better took at top side edge and rear top corners edge of rear cargo area hardtop cover in currently available models are look like in this FIG. 32 is top corner edge at side where vertical and horizontal surface meet at top corner is made curved shape so to install part #50 Hinge for side and rear glass windows to open or close is with solid support additionally designed part #51 curved support has bottom surface is required to make similar curved shape of aluminum or wood type solid material to install surface to surface with top edge curved shape of hardtop cover. This curved shape support has top surface and side surface is flat surface so its top and side surface make right angle to support hinge. Curved support has V shaped countersink at surface and through holes through which long bolt can pass through and those bolts inserted in trough holes of curves shape corner of hardtop cover and tightened with bolt from inside surface of hardtop cover to make solid support to install hinges. Part #50 hinges have some extra holes to pass screws to insert in solid curved support and some holes goes direct inside of rear cargo area hardtop cover at the end portion of hinges. And at other end of hinge towards downside end bolts are installed with, side glass frame.

Part #10 is weather strip to seal part #7 glass when it is closed position for weather protection.

This hinge support installed in vertical curves shape above top curved shape if option 1 model made to open side windows go above the top surface of the rear cargo area hardtop. Hinges are installed down end vertical and upend horizontally install above hardtop cover as shown in FIG. 31 and 32

This same hinge support can be installed in horizontal curved shape if option 1 model made to open side windows to go behind rear glass window of rear cargo area. Hinges must be installed both ends in horizontal position as one end to the side and one end to the rear side of the hardtop like shown in FIG. 6 and 7 regular part #41 hinges are installed at rear edge vertical corner at right angle shape model and if vertical corner is made curved shape than part #51 curved support will go under the part #50 hinges to get solid support with curved shaped hardtop surface.

FIG. 33 Showing enlarged side view of rear side of the rear cargo area has additional designed Part #51 hinge support required to make hinge exactly fit and give solid support to the hinge above curved surface of part #6 rear cargo area top cover if Option 1,2, and Option 3 or any model has rear cargo area top corner is designed to make curved shape for aerodynamic force decrease and better look at top side edge and rear top corners edge of rear cargo area hardtop cover in currently available models are took like in this FIG. 33 is top corner edge where vertical and horizontal surface meet at top corner is made curved shape so to install part #50 Hinge for side and rear glass windows to open or close is with solid support additionally designed part #51 curved support has bottom surface is required to make similar curved shape of aluminum or wood type solid material to install surface to surface with top edge curved shape of hardtop cover. This curved shape support has top surface and side surface is flat surface so its top and side surface make right angle to support hinge. Curved support has V shaped countersink at surface and through holes through which long bolt can pass through and those bolts inserted in trough holes of curves shape corner of hardtop cover and tightened with bolt from inside surface of hardtop cover to make solid support to install hinges. Part #50 hinges have some extra holes to pass screws to insert in solid curved support and some holes goes direct inside of rear cargo area hardtop cover at the end portion of hinges. And at other end of hinge towards downside end bolts are installed with side glass frame.

Part #12 is weather strip to seal part #11 glass when it is closed position for weather protection.

Height of the curved shape should be longer then curved support used in side windows, as per rear glass windows will goes above the both side glass windows when in open position.

FIG. 34 Showing enlarged view for combine attached view of Part #50 hinge and part #51 curved support for side and rear side of the rear cargo area which used in Option 1 model.

It has additional designed Part #51 hinge support required to make hinge exactly fit and give solid support to the hinge above curved surface of rear cargo area top cover if Option 1,2, and Option 3 has rear end vertical side etui or any model has part #6 rear cargo area top corner is designed to make curved shape for aerodynamic force decrease and better look at top side edge, rear side edge and rear top corners edge of rear cargo area hardtop cover in currently available models are similar look like in this FIG. 34 have top corner edge where vertical and horizontal surface meet at top corner is made curved shape so to install part #50 Hinge for side and rear glass windows to open or close is with solid support additionally designed part #51 curved support has bottom surface is required to make similar curved shape of aluminum or wood type solid material to install surface to surface with top edge curved shape of hardtop cover. This curved shape support has top surface and side surface is flat surface so it outside top and side surface make right angle to support hinge. Curved support has V shaped countersink at surface and through holes through which long bolt can pass through and those bolts inserted in trough holes of curves shape corner of hardtop cover and tightened with bolt from inside surface of hardtop cover to make solid support to install hinges. Part #50 hinges have some extra holes to pass screws to insert in solid curved support and some holes goes direct inside of rear cargo area hardtop cover at the end portion of hinges. And at other end of hinge towards downside end bolts are installed with side glass or rear glass frame.

Part #10 and part #12 is weather strip to seal part #7 and part #11 glass when it is closed position FIG. 35 showing as option 3 model to make rear cargo area hardtop cover has both left and right-side glass windows with frame part #55 of rear cargo area hardtop is shown closed on side of hardtop frame at both side these both side window frames relates to one end of each 270-degree rotation hinges part #50 and its other end is attached with at top edge side corners of top surface of the hardtop of rear cargo area outside.

In this figure shown as hardtop cover part #6 has right angle top edge corners so hinge support not shown as installed but if hardtop corner edges made curved shape than hinges need to be installed with hinge support part #51 curved hinge support

side window frame with glass is shown closed and set above the sides of hardtop frame which has L shape support frame little inside surface with weather strip part #10 for weather protection and to hold windows at both front and rear vertical edge and at top horizontal edge. both side window frames are extended at bottom after it's inside T shaped perpendicular frame is set above top surface of factory made body frame to support and hold hardtop cover above it. and shown it has holes to tight screws through it to stay fixed.

both window frames can be locked with through hole screws at exact location of factory made holes with threads on top edge where bottom edge of side window frames go surface to surface inside so window frames stay fixed while driving in high speed and does not make rattling sound,

and its pressed well from outside above the front, rear and top edge weather strips and tighten and locked with screws inside, so, air, wind noise and water cannot enter inside of rear cargo area anytime.

In this option 3 rear glass window is shown as closed at rear side, rear side glass window is connected inside of hardtop cover frame with one end of 90 to 120-degree rotation hinges part #30 and its other end is connected at top of opening of the hardtop cover frame.

both vertical side edge and top edge of hardtop cover frame has weather-stripped part #12 installed when rear glass window is closed than its press surrounding weather-strips and glass is locked with latch lock part #61 installed at both vertical sides of hardtop cover inside, so, no air, wind noise or water ears enter inside.

this glass window frame has weathers tip installed at bottom edge of the glass so when rear door of the vehicle is closed its press to the weather-strip so no air, wind noise or water can enter inside of vehicle.

FIG. 36 in this figure showing as option 3 model to make rear cargo area hardtop cover has both left and right-side glass windows with frame of rear cargo area hardtop is shown opened from its bottom edge with lifting and rotated 270 degrees to upside with support of hinges attached and set above the top surface of the rear cargo area hardtop.

After opened both side windows and set above the top surface of the hardtop it can be locked with rotate latch by Part #62 latch lock installed above the top surface of the hardtop installed above the top surface of the hardtop so it stay fixed while driving in high speed and does not make rattling sound, there is part #63 C shaped rubber cushion installed both sides above the top surface so when window frames set above top surface and pressed by latch lock Part #62 it does not make rattling sound while driving.

but in this option 3 rear glass window is shown opened inside from lifting its bottom edge and rotated 90 to 120 degrees inside with attached inside hinges part #30 towards up and set horizontally parallel with top surface of hardtop and its hold by latch lock part #60 is installed with top horizontal roll cage pipe and it shown locked with 2 latches installed inside with rear edge of top horizontal roll cage pipe so it stays locked while driving the vehicle.

benefit on this option 3 is only two side windows can be set each side above the top of hardtop.

so, each of windows does not touch each other so no scratches or frame damage worry and will not make any rattling noise while driving on high speed because of rubber cushion is installed above the top surface and it can be locked with latch locks.

and rear glass window will be open inside of hardtop and locked with latches at top horizontal roll cage pipe so any of the 3 window's will not touch if vehicle is opened.

FIG. 37 is showing enlarged sketch of part #30 hinges can be used to connect rear glass window to make Option 3 model to open rear glass window open inside of rear cargo area. hinge can be rotate more than 90 degrees if latch lock to hold glass under internal surface of the hardtop cover.

FIG. 38 is showing enlarged sketch of part #50 to make option 3 model to make open side windows and rotate to 270 degrees outside of the rear cargo area hardtop.

FIG. 39 is showing enlarged sketch of part #61 sliding latch lock to close rear glass window in making option 3 rear cargo area hardtop window, it has rectangular shaped metal latch inside of rectangular frame which can be installed inside at rear wall of rear cargo area hardtop to lock rear glass window when it is at closed position, so weather-strip at bottom edge of rear glass window will be pressed by top edge of factory made rear door of the vehicle, so, air or water cannot be entering inside of the vehicle.

FIG. 40 is showing option 3 as rear glass window open outside rotation from its bottom to top and it's at horizontal position than it can be slide its part #66 roller hinge installed at both top side corner ends of the rear glass window in with C shape channel at both side in part #65. and in center at top edge of the glass part #68 ball point hinge will be slide inside of down side open hanging part #67 C shaped channel. so as per more length of rear window glass it will get strong holding support in center for top edge of the glass.

FIG. 41 is showing part #70 F lock will give support to the bottom edge of the glass when it's at opened position. This F Lock is installed at rear wall of the rear cargo area hardtop exactly above the opening of the rear glass window and its stay horizontal while rear glass window is at closed position with roller knob above the rear wall of hardtop surface. This lock is attached at only with its through hole with screw on surface and its top C shape portion of F is can be rotate 360 degrees when it required to hold the bottom edge of the rear glass window when its opened and inserted inside of rear cargo area so while driving the vehicle in rear window as opened position, bottom edge of the rear glass window will be hold with F as down position and its top F shape plates will rotate inside so glass will be hold by its top F portion which has rubber grip in it so glass will not make any rattling noise while driving the vehicle.

FIG. 42 is showing complete rear cargo area hardtop cover as both left and right-side windows are opened and rotated outside upward at 270 degrees and set above the top surface of the hardtop cover and its locked by part #62 latch lock fixed above the top surface of hardtop cover, there is Part #63 rubber cushion is installed above the top surface of the hardtop so when both side windows set above it and its pressed by latch lock, so it will not make any rattling sounds while driving the vehicle.

Rear glass window part #11 is shown as open and inserted inside of rear cargo area through its both side end in c shaped channel and hold by its extended C shaped frame inside and its top center edge ball point hinge is slides inside in downside open C shape channel, bottom edge of rear glass window is locked by part #70 F shape lock is rotated down and its half top F portion is rotated inside of cargo area so bottom edge of glass window is in gap of F shaped knob will stay fixed and center of top edge of glass will hold by downside open C shape channel inside of rear cargo area so cannot make rattling sounds while driving the vehicle.

with this slide in rear glass window inside of rear cargo area as additional option will avoid any of the rattling noise or scratches issues as of setting both side windows above the top and rear glass window as opened and slides inside of rear cargo area. so, none of the windows will touch with each other's.

FIG. 43 is showing additional option in option 3 for rear glass window open to completely remove in this option 3 as shown in figure to avoid all 3 windows gather parallel at one surface and make rattling noise. part #11 rear glass window shown as lifted outside upward and made at horizontal position. its Part #74 Right shaft at top corner is lifted little up from Part #75 C shape Hinge cylinder and it can be slide little towards right side as its already tilted up out of Upside opened C shape hinge cylinder opening so Part #72 left top corner shaft can be pulled out from part #71 fixed cylinder hinge. so, complete glass assembly can be remove from hardtop cover frame and can be store inside of rear cargo area floor will make rear window completely removed to pass air from rear window frame of rear cargo area.

FIG. 44 is showing enlarged sketch of Part #72 left top corner shaft is inserted in Part #71 fixed cylinder hinge as part #11 glass window is attached in it and as horizontal position.

FIG. 45 is showing enlarged sketch from right side of Part #74 right shaft at top corner is inside of part #75 C shape Hinge cylinder has opening at top side, rear glass window is attached with part #74 right shaft clamp and shown as glass in horizontal position. this shaft inside of hinge cylinder is made from circular road and it's both sides are trimmed so it can be pull out through C shape opening of C shape hinge and its top and bottom circular surface can give fixed holding as shaft will be in horizontal position inside c shape hinge cylinder while glass is in vertical position as closed on the frame of the hardtop cover so complete glass assembly stay secured above the frame.

FIG. 46 is showing enlarged sketch from left side of Part #74 right shaft at top corner is inside of part #75 C shape Hinge cylinder has opening at top side, rear glass window is attached with part #74 right shaft clamp and shown as glass in horizontal position, this shaft inside of hinge cylinder is made from circular road and it's both side are being trimmed so it can be pull out through C shape opening of C shape hinge and its top and bottom circular surface can give fixed holdings shaft will be in horizontal position inside c shape hinge cylinder while glass is in vertical position as closed on the frame of the hardtop cover so complete glass assembly stay secured above the frame.

this technic can be applied on both side windows of rear cargo area of hardtop too, to open and remove the glass front side window frames and store inside of the rear cargo area.

FIG. 47 is showing if both of the left and right side windows if need to remove completely, then as shown in FIG. 47 and 48 part #55 side window frame has 2 part #91 extended plate installed above the top edge which can be inserted inside of part #90 holding slot which is installed at top edge of the rear cargo area hardtop frame as shown in FIG. 47 side window frame is fixed on frame of hardtop cover below the edge of window frame part #10 weather strip will be pressed to give weather protection when it's at closed position, so when if need to open, 2 screws need to be removed from the inside at bottom edge of side window frame which is fixed with factory made top surface threaded through holes, so bottom edge can be lift up outside and complete window frame can be pulled downside so part #91 extended plate will come out from both holding slot and window will be removed completely to store in rear cargo area. That is make side window frame open for open air driving experience.

FIG. 48 is an enlarged sketch of part #91 and part #90.

FIG. 49 is showing there is one more option and if both left and right-side windows need to remove completely, then as shown in FIG. 49 and 50. part #55 side window frame has part #93 right. cylinder hinge installed above the top surface at side top corner of the hardtop cover which can be slide with rotation of attached assembly lock handle. this cylinder hinge pipe will hold part #91 hinge shaft which is installed at top right corner of part #55 window frame when side window frame need to at closed position, if side window frame need to be remove from the hardtop cover frame than part #93 assembly handle can be rotate to slide cylinder hinge cover toward right so top corner hinge shaft will be open. then this right corner can be pull out little from the hardtop frame so complete frame can be pull right side to release fixed hinge shaft at left top edge corner above window frame. once complete frame will remove it can be store on floor of rear cargo area hardtop for open air driving experience.

if side window frame part #55 is fixed on frame of hardtop cover, window frame will press part #10 weather strip to give weather protection when it's at closed position, so when if need to open, 2 screws need to be removed from the inside at bottom edge of side window frame which is fixed with factory made top surface threaded through holes, so bottom edge can be lift up outside and complete window frame can be pulled downside so part #91 extended plate will come out from both holding slot and window will be removed completely to store in rear cargo area. That is make side window frame open for open air driving experience.

FIG. 50 is an enlarged sketch of part #92 and part #93

FIG. 51 shown This Invention also offer additional type of soft cover Showing Part #26 soft top cover additionally optional feature part made with flexible PVC or plastic kind of material either in clear vision, tinted or medium dark semi vision through material is additional feature to install above complete front and rear seating area top side when both left and right side freedom panels not installed above the vehicle top area for sun roof/moon roof kind of natural lighting driving experience and also for protection of weather inside of the both front and rear seating area with rubber sealing front edge part #27 Front slots clamp inserted and tight above top edge of front windshield and rubber sealing part #28 angle slot clamp insert to rear side top slot rearward facing slot of top surface above central cover and fit straight left to right side ends of the vehicle, left side and right side ends of soft cover has thick part #29 side rubber sealing hard material will stay down side straight both sides of vehicle top edge and it left and right side rubber sealing rim will seal with top edge frame of both left and right side front and rear doors of the vehicle

In FIG. 52 Showing side view of Soft cover can see at top and front end has Part #27 front slot, right end shows part #28 angle slot and in middle showing side facing part #29 side rubber sealing.

FIG. 53 showing Part #87 Adjustable Hardtop support with assembly of Part #83, Part #82, part #84, and part #86 can be installed at multiple locations above the part #15 Roll cage pipe to support, Part #100 central cover, top surface of part #6 rear cargo area top cover on rear cargo area.

Part #86 Top support has top surface plate can be attach or give vertical support to the hardtop cover from inside of the vehicle at many places where required vertical support as any of the option model made to open both side windows open for open air driving experience.

below the top surface place threaded bolt is attached.

Part #83 is cylinder pipe threaded inside where and it has nerd finish for manually grip rotation and nut shape outer surface to use tool to tight with Part #86 threaded bottom end which can be insert with rotation of this internal treaded cylinder to adjust the height for installation of the hardtop cover above the vehicle.

this cylinder pipe has 4 threaded holes at its bottom portion.

through this threaded boles screws can be tighten in inside of piston ring slot of part #84 piston ring holder so this screws will let part #86-cylinder pipe to rotate but will stay fixed on part #84 Piston ring

below the part #84 piston ring support one vertical plate has hole and its attached with 2 jaws as part #82 jaws in half circular shape, these 2 jaws can be opened and fixed above the part #15 roll cage pipe which installed on factory made vehicle and it can be tight with screw at its bottom end.

so, once this jaw is fixed above the roll cage pipe Part #83-cylinder pipe is in middle of part #84 Piston ring support and top support it can be rotate as required to adjust the height of top support and keep fixed as very large size fiber glass body installation above the vehicle.

FIG. 54 shown complete view of as Option 4 as a combination of selection on above mentioned options 1,2 and 3 to make Open convertible windows of rear cargo area hardtop when manufactured new or on existing factory-made hardtop to modify if it is as curved shape at top horizontal at sides and at rear, vertical cut at rear edge of both side windows and horizontal cut on both side windows at top edge must require modifying existing factory made hard top cover to install conversion kit

This is a similar option as mentioned new clear drawing attached for clarity on those option 1,2 and 3 to select which features users like to be installed if top horizontal corner is in curved shape. FIG. 54 is completely closed Jeep type SUV with its part #3 and #4 Freedom panels is at closed position and both left and right-side windows is as closed position and rear glass window also shown as closed position with vertical rear edge of the both side windows has vertical extension of plate part #10 with weather strip to get pressure on weather strip when windows are at closed position, plus additional plate support is installed at inside edge of top of the both side windows when both side window will be at closed position, also Part #22 weather strip is installed at bottom edge of the rear glass windows as shown in FIG. 56.

As shown in FIG. 54 both side windows are attached with removable hinges in 2 parts as mention with Part #98 fixed hinge portion which can be installed permanently with rear cargo area hardtop cover frame above the part #51 Hinge support below all side windows as top horizontal edge is in curved shapes. Part #99 removable hinge portion is attached permanently with both side window frames at top edge surface with screws.

Similar way Part #98 fixed hinges are attached with rear cargo area at bottom edge of the opening frame above top edge of the rear glass window. Part #99 removable hinge portion is attached with rear glass window at top edge and shown as all side window and rear glass window removable hinges are inserted above the shaft of the part #98 fixed hinge. If user want to remove the rear glass window, then it need to be opened upwards from its bottom edge and rotate up to 150 degrees till locking knob of the part #99 is open to slide out to the right side. So, it can be removed from the shaft of part #98

Part #95 Right angled power motor is installed at both rear top edge corner of the hardtop cover and it is attached with motor shaft with Part #96 vertical plate with both side windows at rear vertical edge surface to rotate window with power motor toward upside of top surface with 270 degrees rotation.

This hinge is specially designed as if users want to open the side windows and set above the hardtop cover either manually or with help of part #95 Power motor to set above the hardtop cover while driving the vehicle and no required to store and keep safe inside of rear cargo area or to store in garage.

But if some of the user do not want to set above the hard top cover and want to remove it completely then it can be remove once it opened as lifted from bottom edge of the side window and lifted upwards till it's release knob comes up as open to slide out to remove the window. Part #96 rotation plate is designed as it can be removed from the shaft of the part #95 power motor. And it can be stored on the floor of the rear cargo area to feel open air driving experience if used do not want to set side windows above the hard top.

FIG. 55 is showing complete opened Jeep type SUV showing complete view of as Option 4 is a combination of selection on above mentioned options 1,2 and 3 to make Open convertible windows of rear cargo area hardtop when manufactured new or on existing factory-made hardtop to modify if it is as curved shape at top horizontal at sides and at rear, as showing front seating area part #3 and #4 freedom panels are removed from the top cover. As showing in the figure both side windows of rear cargo area hardtop is opened and set above the hardtop

Showing vertical rear edge of the both side window frame has vertical extension of plate part #10 with weather strip to get pressure on weather strip when windows are at closed position, plus additional plate support is installed at inside edge of top of the both side window frame in horizontal position so when both side window will be at closed position its seal the window edges at top and rear vertical edges.

Front vertical edge has inside bended extension strip where rear door frame close with weather strip when door will have closed. Bottom portion of the window has extended material cover with inside right-angle plate above the top edge of the Main body frame of Jeep type SUV.

This is a similar option as mentioned new clear drawing attached for clarity on those option 1,2 and 3 to select which features users like to be installed if top horizontal corner is in curved shape.

Part #7 both left and right-side windows is opened from its bottom edge and lifted upwards to rotate 270 degrees as shown in FIG. 55 with part #95 power motor attached with Part #96 rotation plate attached with both side windows at rear vertical edge of the side windows. and part #11 rear glass window also shown as opened from its bottom edge and lifted about 150 degrees upwards, so its Part #99 removable hinge can be slide towards right-side so its cylinder of hinge will be separated from the shaft of the Part #98 fixed hinges and separated rear window glass from rear end of the hardtop cover frame.

FIG. 56 showing part #11 rear glass window is separated from the rear frame of the hardtop cover frame of the vehicle. On which Part #99 removable hinges are shown at top edge of the glass window. Part #22 weather strip is installed at bottom edge of the rear glass windows as shown in FIG. 56 which can be sealed with rear cargo area door when rear door will be at closed position.

FIG. 57 is enlarged view of the left side window frame of part #6 rear cargo area hardtop frame with part #7 left side window is at closed position as inserted both part #99 removable hinge cylinder is hold by part #98 fixed hinge shaft. Part #95 right angled power motor is installed above top rear end corner of the rear cargo area hardtop cover which relates to Part #96 rotation plate is installed permanently on outer vertical rear end of the window frame. Part #51 hinge support is installed above the carve at tile top edge corner to make right angle to the Part #98 fixed hinge above it. part #10 extension plate is installed vertical at rear vertical inside edge of the rear cargo area hardtop frame and in horizontal position at inside edge at top of the window frame to seal with weather strip with rear vertical and top horizontal edge of the window frame when side window will be at closed position.

FIG. 58 is showing combined assembly of Part #98 fixed hinge and part #99 removable hinge in position will look attached window at closed position. Part #98 fixed hinge will be fixed with the screws on top edge of the rear cargo area hardtop, this hinge is made as it has a horizontal piston shaft, this shaft has extra solid metal material in the center of the shaft in half cylinder shape like holding knob. There is a gap between holding knob and left side end of full cylinder from where shaft is coming out. As shown in FIG. 58 Part #99 is inserted above the shaft of part #98 and rotated downward so extended locking knob will be rotate inside the gap of it so window can be remove on any circumstances.

FIG. 59 is showing combined assembly of Part #98 fixed hinge and part #99 removable hinge in position will look attached window at open position. Part #98 fixed hinge will be fixed with the screws on top edge of the rear cargo area hardtop, this hinge is made as it has a horizontal piston shaft, this shaft has extra solid metal material in the center of the shaft in half cylinder shape like holding knob. Now as shown in figure part #99 is as open window position up to 150 degrees rotation so locking knob is open to slide above the shaft to right side, so attached window can be slide to right as 2 of the part #99 removable hinges can be release from the shaft manually.

FIG. 60 is enlarged view of only part #98 Fixed hinge as showing it has a shaft and above the shaft extended cylinder to hold the locking knob of removable hinge when it is required to close the window.

FIG. 61 is enlarged view of only part #99 removable hinge has cylinder on bottom edge as shown in figure which can be cover up above the shaft of part #98 fixed hinge shaft passing through gap between wall of hinge and holding knob above the shaft. Once cylinder covered up complete shaft then its locking knob can be rotate downwards in between gap of extended holding knob and left side of the cylinder from where shaft is coming out. So, window can be closed, and it will not release until window will open upwards and rotated about 150 degrees.

FIG. 62 is an enlarged view of part #51 hinge support which must require installing as support to the hinges on curved shape hardtop cover at top horizontal corner to make right angle to rotate hinges at 270 degrees when require opening and closing the windows.

FIG. 63 is an enlarged view of part #95 right angled motor and part #96 rotation plate. FIG. 63 is showing as right-angle motor has powered motor attached with the right-angle gear box and rotation shaft of the motor is shown on the right side of the gear box which shaft should be in the center line with shaft of the both part #98 fixed hinges installed above the top edge corner of the hardtop cover. Part #96 rotation plate will be installed permanently on the both side window frames at the rear vertical edge as its top portion has exact gap to cover shaft of the Part #95 Power motor on the left side. So, when user want to install the complete window assembly side window assembly only can be inserted at 150 degrees from the vertical surface of the hardtop cover frame as mentioned for Part #99 removable hinge has locking knob should pass through the gap above the shaft of the part #98 manually towards power motor shaft. This 2 removable hinges and rotation plates top portion can be inserted all together only above the shaft. This option is for only those users who do not want to set side windows above the top of the hardtop cover whole rear cargo area is opened.

If User do not want to remove side windows from the hardtop cover frame, then it can be open and close anytime by power switch which control the Part #95 right angle motor, then extra lock or some extended lock should be install permanently to lock the window above the top surface while it is opened and do not slide towards front while applying the break on the vehicle.

FIG. 64 is showing complete opened Jeep type SUV showing complete view of as Option 4 is a combination of selection on above mentioned options 1,2 and 3 to make Open convertible windows of rear cargo area hardtop when manufactured new or on existing factory-made hardtop to modify if it is as curved shape at top horizontal at sides and at rear, as showing front seating area part #3 and #4 freedom panels are removed from the top cover. As showing in the figure both side windows of rear cargo area hardtop is opened and removed from the rear cargo area hardtop cover

Showing vertical rear edge of the both side window frame has vertical extension of plate part #10 with weather strip to get pressure on weather strip when windows are at closed position, plus additional plate support is installed at inside edge of top of the both side window frame in horizontal position so when both side window will be at closed position its seal the window edges at top and rear vertical edges.

Front vertical edge has inside bended extension strip where rear door frame close with weather strip when door will have closed. Bottom portion of the window has extended material cover with inside right-angle plate above the top edge of the Main body frame of Jeep type SUV.

This is a similar option as mentioned new clear drawing attached for clarity on those option 1,2 and 3 to select which features users like to be installed if top horizontal corner is in curved shape.

Part #7 both left and right-side windows is opened from its bottom edge and lifted upwards to rotate 150 degrees to remove the part #99 removable hinge from part #98 fixed hinges and slid other direction so part #96 will also release from the shaft of the part #95 right angle motor. and part #11 rear glass window also shown as opened from its bottom edge and lifted about 150 degrees upwards, so its Part #99 removable hinge can be slide towards right-side so its cylinder of hinge will be separated front the shaft of the Part #8 fixed hinges and separated rear window glass from rear end of the hardtop cover frame. Part number 7 side windows show separately after removed from the hardtop cover as FIG. 66 is a left side window and FIG. 67 is a right-side window.

FIG. 65 showing part #11 rear glass window is separated from the rear frame of the hardtop cover frame of the vehicle from rear. On which Part #99 removable hinges are shown at top edge of the glass window. Part #22 weather strip is installed at bottom edge of the rear glass windows as shown in FIG. 56 which can be sealed with rear cargo area door when rear door will be at closed position.

FIG. 66 is an enlarged image of Part #7 left side window shown separately after removed from the hardtop cover as it is a left side window on which as shown extended bent plate is towards front to get pressure front the weather strip on the vertical edge or the rear door.

FIG. 67 is an enlarged image of Part #7 right-side window shown separately after removed from the hardtop cover as it is a right-side window on which as shown extended bent plate is towards front to get pressure from the weather strip on the vertical edge or the rear door.

FIG. 68 is an Enlarged view to make this 5th Option for rear cargo area of the vehicle with Rear cargo area top cover showing as closed above the rear cargo area. Which can be open entire top, sides and rear area of the rear cargo area of the Jeep type sports utility vehicle and can be applied to make this system on any Pick-lip truck or any semi pick-up truck has rear cargo area opened. In Jeep type Sports vehicle. Roll cage pipes in rear cargo area need to be removed from the ends behind the rear seat, so rear cargo area will not have any solid frame structure on the way as per this this 6th option need to make as fully convertible to open and insert inside of the floor of the rear cargo area as inbuilt on the vehicle.

Part #100 Central cover is a supplementary solid material frame will be installed above the factory made jeep type SUV as shown in FIG. 68 this central cover will cover above the rear seat of the vehicle, and the sides with it will have additional extended wall will resides of the top of the factory made frame structure, and it will also extended above the side frame of the rear wall of left and right-side factory made frame structure to raise partial heights on both sides so there will be ample height for Rear cargo area top cover can be inserted properly when it will be rotated and flip over to open the rear cargo area,

At front side this central cover covers to an additional supporting metal part #15 roll cage pipe behind the rear seat area and its bottom end is installed with factory made jeep structure to give vertical support to the factory-made roll cage pipes installed at top of the vehicle for safety, at top front surface there is a supporting slot to install part #3 and 4 top freedom panels

Part #103 weather strip supportive frame is installed in reverse C shape as it can be slide front or backwards to support Part #102 rear cargo area top cover at its front end to seal the top cover.

2 pieces of Part #104 release latch is connected to Part #103 weather strip supportive frame at both sides to move forward or backwards weather strip supportive frame by rotation when it is required to open or close the rear cargo area top cover.

Part #101 Extension plate made with solid material above rear door will have installed permanently is an extended supplementary part to install above the top surface of the rear door, so whenever rear door will open or closed it will move with the rear door

Part #102 rear cargo area Top cover for rear cargo area is a special designed hard top cover to install above the top surface of the rear cargo area. Which have front area is opened as C shape and its inside frame has opening on front side so vehicle has opening on rear cargo area when it is at closed position, its sealed with surface contact above the Part #103 weather strip supportive frame which will be slide backwards with rotation of the part #104 release latches. at rear side wall there will be part #107 Rear glass window will be attached with 2 hinges at top edge of the window. Part #106 Latch lock is installed on part #107 rear glass window to lock rear glass with part #102 rear cargo area top cover when its required to open the rear cargo area or even while driving the vehicle to secure rear cargo area.

Part #105 Convertible Hinge is a solid metal hinge connector is shown as installed in center above the top surface of the left side of the part #100 central cover as its top end of its T shape is attached with hinge cover which connected with left side edge of the part #102 rear cargo area top cover. Vertical cylindrical shaft of this hinge relates to circular solid metal plate at bottom is locked by 2 horizontal plate with screws upside attached with bottom surface of the part #100 in which vertical shaft of T part of the hinge pass through to rotate in horizontal 180 degrees rotation when its required to open or close part #102 rear cargo area top cover. This circular plate will be fastened by 2 horizontal plate both front and rear side to hold tight the circular plate in which T shape shaft is inserted to make solid support while rotating the part #102 rear cargo area top cover.

Top right corner arrow shows direction of part #102 can be lifted upward to rotate at 90 degrees when its required to open the rear cargo area

FIG. 69 showing perspective view of how Part #102 rear cargo area top cover is lifted upwards in vertical direction to rotate 90 degrees lifted front right side top surface of the part #102 central cover left rear side and its showing as it in middle of its 180 degrees horizontal rotation to flip over the top cover, as its attached with Part #105 Convertible hinge top T shaft's horizontal which has vertical T shape shaft is attached inside with Part #100 Central cover's left rear side surface at center of its left side edge.

Both Part #104 on both sides is rotated to pull part #103 Weather strip supportive plate towards front side of the vehicle to make open space on entire C shape area of the rear top end of the part #100 for clear path for 180 degrees rotation of Part #102 rear cargo area top cover.

At bottom of the image 69 shown arrow below the center of the part #105 Convertible Hinge is to show direction of 180 degrees rotation of part #102 rear cargo area top cover.

In FIG. 69 is shown as part #102 in middle of the rotation to complete the 180 degrees rotation and its will be inserted down with 90 degrees rotation down towards empty container space in rear cargo area in next FIG. 70

In FIG. 70 Showing as part #102 rear cargo area top cover is completely inserted in empty rear cargo area of the vehicle with completed rest of the horizontal rotation of the 180 degrees from as shown in FIG. 69 and then entire part #102 is rotated downwards in vertical rotation 90 degrees rotation to insert in rear cargo area.

First required vertical rotation of 90 degrees to open the part #102 rear cargo area to make entire top cover from horizontal to vertical position need to be lifted from right to left side, then only it can be rotate 180 degrees horizontal rotation to change flip over the top of the hardtop toward bottom of the rear cargo area

then last step is to make rear cargo area top cover will be rotate in vertical rotation from left to right at 90 degrees to insert in rear cargo area.

This 3 steps rotation can be possible manually only to open complete top, sides and rear cargo area opened as look like Pickup truck for passing and cleat view in rear cargo area for open area driving experience, as on rest of all these 5 opt ions explained front two row seating area both left and right-side top freedom top panels of the passenger area can be remove and stored inside of this flip over part #102 Rear cargo area top cover which inserted in rear cargo area.

Both of front and rear and both sides if it's a 2 door or 4 door vehicle side windows can be inserted inside of the door panels with manually or by power motors as Factory made vehicle.

So, to make maximum opening of the Vehicle requirement this Convertible option on rear cargo area is only can be install in rear cargo area when Part #15 roll cage pipe will be removed, and it is supported by extension to the sides behind the rear seats from the existing Jeep type SUV as it is required for safety in case of the rollover. Also, L shape solid metal support can be added inside at all top and side corners of the part #102 rear cargo area top cover to give solid protection on rear cargo area where only goods or recreation stuff stored.

This option of the invention offers all front and rear seating area passengers with 100% safety as roll cage pipes is removed only in rear cargo area to make fully convertible option to open entire top, side and rear walls to open and insert inside of rear cargo area with inbuilt mechanism to open and close the vehicle with hardtop anytime and at anyplace when it required to open or secure.

FIG. 71 is enlarged Image of Part #105 Convertible hinge showing how it is attached below Part #100 Central cover as its top surface edge in between 2 horizontal plates underneath and its vertical shaft pass through it to attach with top shaft of T with hinge covers attached with part #102 Rear cargo area top cover at its left side horizontal end on left side of the vehicle in center of left side edge.

### DETAILED DESCRIPTION OF THE INVENTION

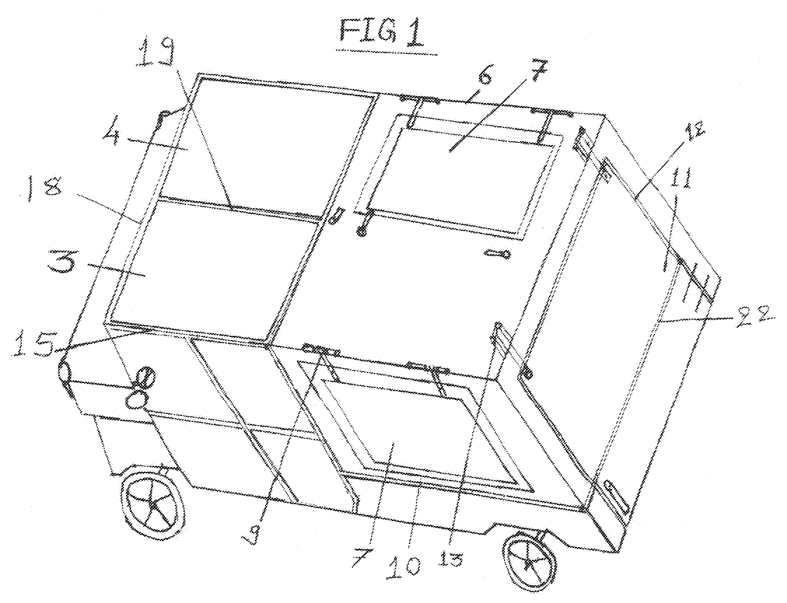

In FIG. 1 shown a perspective view of the present invention from left rear side of the vehicle. All parte are installed in an assembled slate above the vehicle as closed all part above the vehicle to secure passenger and rear cargo area of the vehicle.

Front and Rear sealing area is covered at the top of the vehicle with part #3 is a left (driver) side freedom panel and part #4 is a right (Passenger) side freedom panel and with openable convertible hardtop cover at rear cargo area above the Jeep type sports utility vehicle on Jeep type vehicle manufacturers make open at the top and rear cargo area to leave open air driving experience for users with rear cargo area open to load big size goods to transport.

So, users install two types of top and rear cargo area covers above this vehicle to utilize their requirements while driving with self or with passengers and parking when vehicle is not occupied.

Some of users install fiberglass or Plastic kind rigid material hardtop cover and install permanently Fixed above the top and rear cargo area which is available in aftermarket of automobile industry.

Some of aftermarket manufacturers make this hardtop has 2 separate freedom panels to install or can be removed from top at passenger area for open air driving experience.

But rear seating and rear cargo area top cover stay closed all the time at sides and at the top. This kind of hard top gives full protection to the passenger and interior of the vehicle from rain water, Dust, wind noise while driving or parked. But it is not convertible hardtop cover as per it cannot be open at rear cargo area at top or at sides.

Whenever users want to utilize open air driving experience they must uninstall entire hardtop cover and remove from the vehicle and store-in garage or at safe location with one person help as per large size and it heavy weight and it took so long time to uninstall from the vehicle.

So, once it is removed from the vehicle and stored at safe location. It is not with the complete opened vehicle anywhere user goes to enjoy open air driving experience.

But, user don't have any protection from weather while driving or parking or from weather and stealers to cover up to close the vehicle whatever places they park open vehicle.

Some of users install soft top cover above the top and rear cargo area for open air driving experience as per soft top can be open some of the windows at sides and rear of the vehicle to enjoy open air driving experience available from the aftermarket of the automobile industry.

Some of users install automatic convertible soft top cover above the top and rear cargo area for open air driving experience as per convertible collapsible soft top cover can be open at top and rear cargo area with powered mechanism and store itself in rear cargo area to enjoy open air driving experience available from the aftermarket of the automobile industry. But this type of convertible soft top covers is very expensive (almost 3 times high price) due to automatic power mechanism cost high for manufacturer.

Soft top like all this types has so many disadvantages are like flapping noise, wind noise, air or water leak, unclear visibility at sides and rear glass. also, it is not protective for extreme heat or cold weather due to no insulation inside of its layer, easy to cut for stealers and it is cannot be made in matching color with vehicle because of it is not rigid flat material.

This Invention offers so many problems resolved for users with Hardtop open cover to give complete rigid hardtop protection with anytime and any where to convert vehicle in full protection from weather and stealer or can be open for open air driving experience as per it can be installed permanently above the vehicle and can be converted for open air driving whenever user want to and can be convert to close position while parked.

1st option is showing both left right freedom panel can be install or remove from top and both rear side and rear window can be open and can be set above the openable hardtop roof manually after each of rotated at 270 degrees outside of the vehicle.

In this First option left and driver side window and rear window can be power motorized at hinges above top surface with reverse gear to open and close the window by power button installed at dash board and make automatic convertible rear cargo area.

Initially right (passenger) side freedom panel is installed above 2 edges to support and sealed tight with latches at front to the top of the front windshield frame of the vehicle and rearward above the bottom slot of the part #6 openable hardtop permanently installed behind rear seating area and its tightened with screw from inside at front side bottom slot of openable hardtop.

Part #4 Right freedom panel front edge with support and sealed tight with latches at front to the top of the front windshield frame of the vehicle and rearward above the bottom slot of the part #6 Right edge of part #4 a Right (passenger) side freedom panel is open at bottom to open and close passenger side both front and rear side doors. It's left (driver) side edge has a slot at bottom to hold and support part #3 a left (driver) side freedom panel edge toward passenger side edge.

Part #4 Right side freedom panel is tightened at center from inside by screw with Part #15 a Roll cage pipe already installed on existing vehicle above the front seating area of the existing vehicle

Above it part #3 a left (driver) side freedom panel is installed above 2 edges to support and sealed tight with latches at front to the top of the front windshield frame of the vehicle and rearward above the bottom slot of the part #6 openable hardtop permanently installed at rear cargo area and its tightened with screw from inside of the openable hardtop cover

Left edge of part #3 a Left (Driver) side freedom panel is open at bottom left side to open and close driver side both front and rear side doors, its right (passenger side edge) has a slot at the top to fit above bottom slot of the right passenger side freedom panel to seal with part #4 a right (passenger) side freedom panel edge toward passenger side edge.

Part #3 left side freedom panel is tightened at center from inside by screw with Part #15 is Roll cage pipe already installed above the front seating area of the existing jeep type vehicle

Part #18 a rubber sealing channel is installed above the top side bottom slot where freedom panel's rear ends rest and tighten with screws to seal both bottom of the part #3 and part #4 left and right side freedom panels respectively to protect wafer leakage inside of the vehicle

Part #6 has horizontal slot at bottom rear end corner for water drainage to protect rain water enter between vertical rear end edge of both freedom panels at top of the vehicle.

Part #6 is openable convertible hardtop cover installed above rear cargo area and installed permanently. It is installed above top edge of both side of the rear cargo area of the existing Jeep type of vehicle.

The top horizontal frame has a slot to give support and tightening through hole from inside to hold part #3 and part #4 left sides and right freedom panel respectively,

front top surface slot above this hardtop Part #18 a rubber sealing channel is installed above the top side bottom slot where freedom panels end rest and tighten with screws to seal both bottom of the part #3 and part #4 left and right side freedom panels respectively to protect water leakage inside of the vehicle. Part #6 has horizontal slot at bottom rear end corner for water drainage to protect rain water enter between vertical rear end edge of both freedom panels at top of the vehicle.

Now in this option left and driver side window and rear window can be power motorized at hinges above top surface with reverse gear to open and close the window by power button installed at dash board and make automatic convertible rear cargo area.

This Description is for manual operation

Part #7 Left (driver) side window with frame relates to part #9 short lunges which installed above left top edge of hardtop and shown as closed window at left side of the vehicle.

Part #7 Right side glass window with frame relates to part #9 short hinges which installed above right top edge of hardtop and shown as opened window outside from right side of the vehicle and rotated about 270 degrees upward counter clock wise and placed above hardtop cover on right side of the vehicle.

Part #11 rear glass window relates to Part #13 tall hinges above the rear top edge of hardtop and shown as closed at rear window of the vehicle. part #12 rubber sealing part installed at inside edge at rear window frame of hardtop for weather protection showing in FIG. 1 shown left side window frame is closed at left side of the vehicle.

Part #19 is weather strip seal both left and right-side freedom top panel which is installed at top side slot of part #4 above which right side of part #3 seats to close the top cover.

Part #15 is Roll Cage Pipes run above the top of the vehicle for safety as factory made model

rear window frame is shown closed at rear side of the vehicle, but right-side window frame is opened from right side of the vehicle and set horizontally above the top of the right side openable hardtop to show clear optional description of The Invention.

Now if user want to open the vehicle at top and every sides is shown in

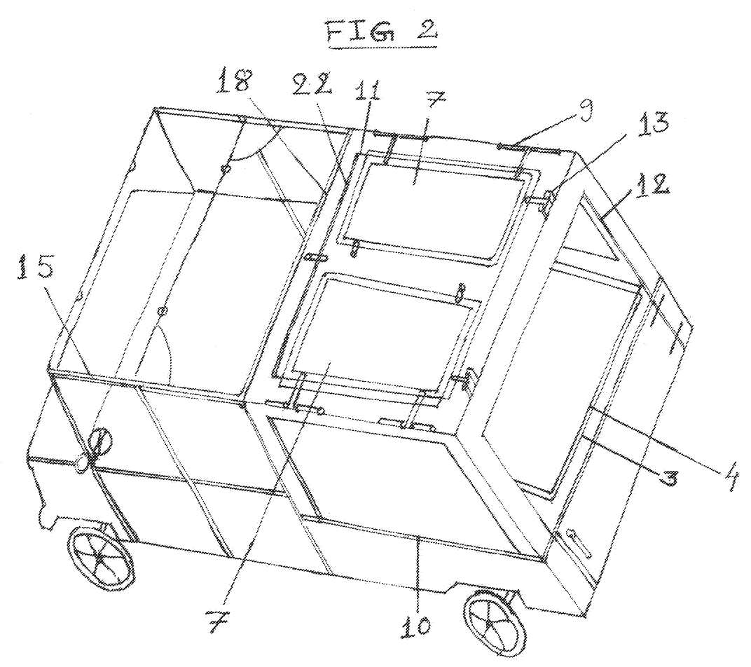

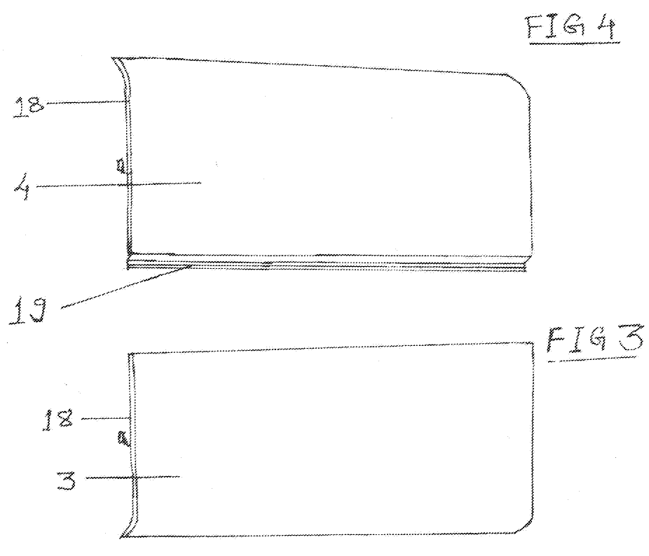

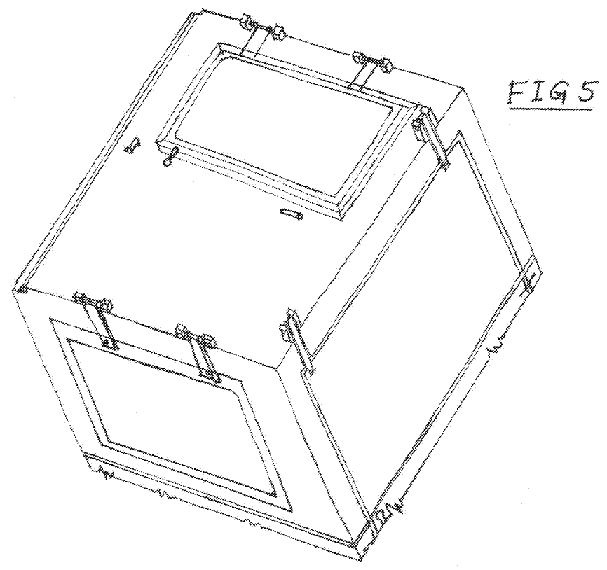

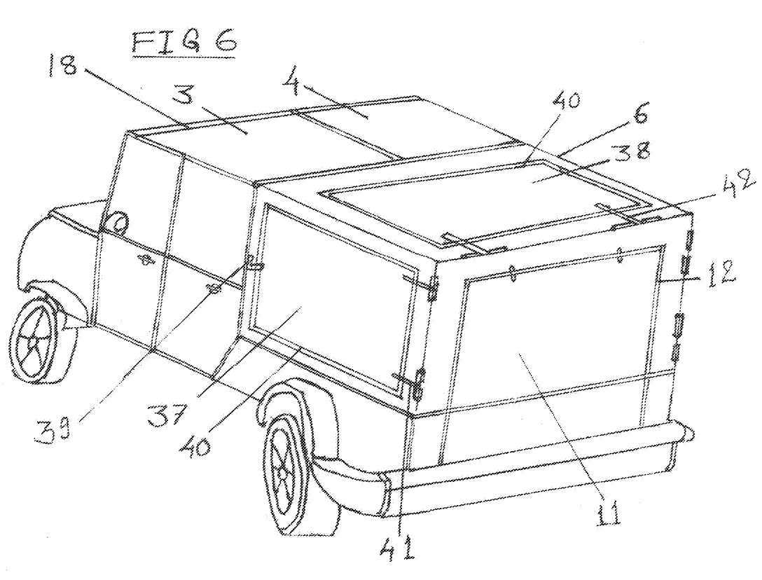

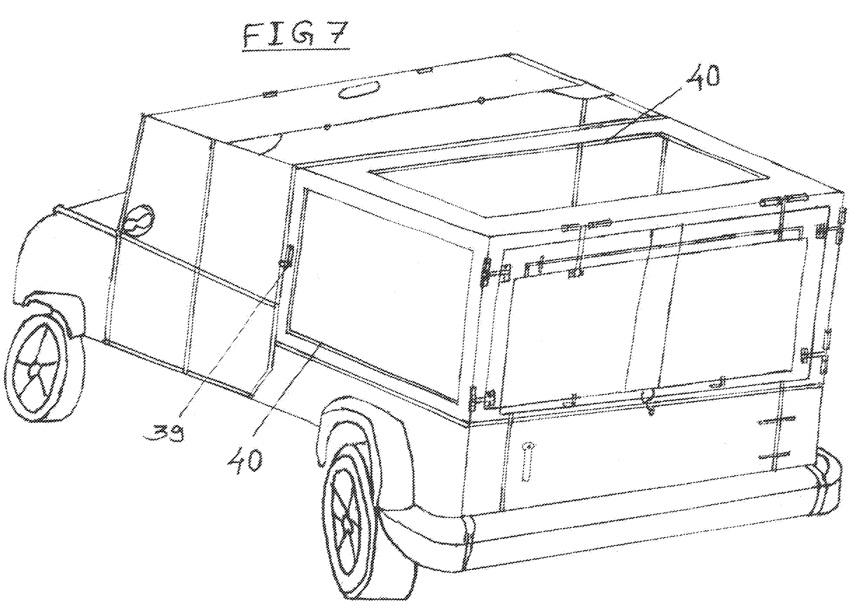

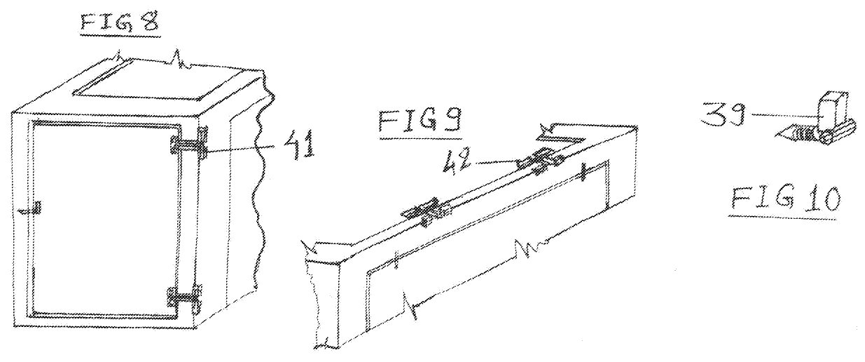

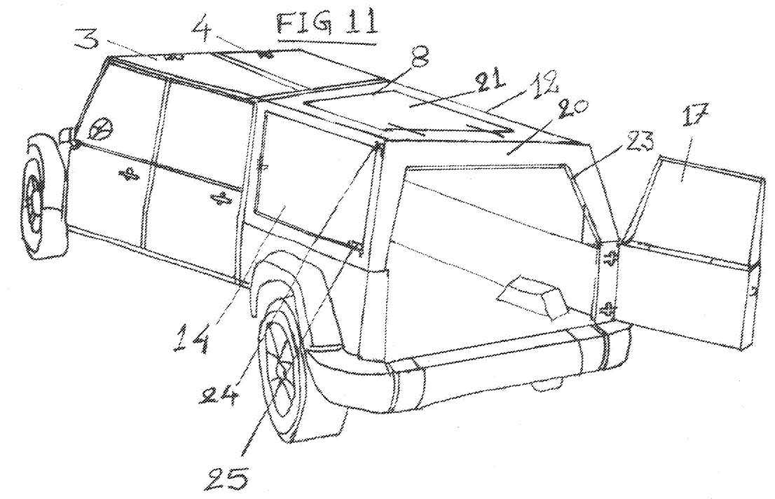

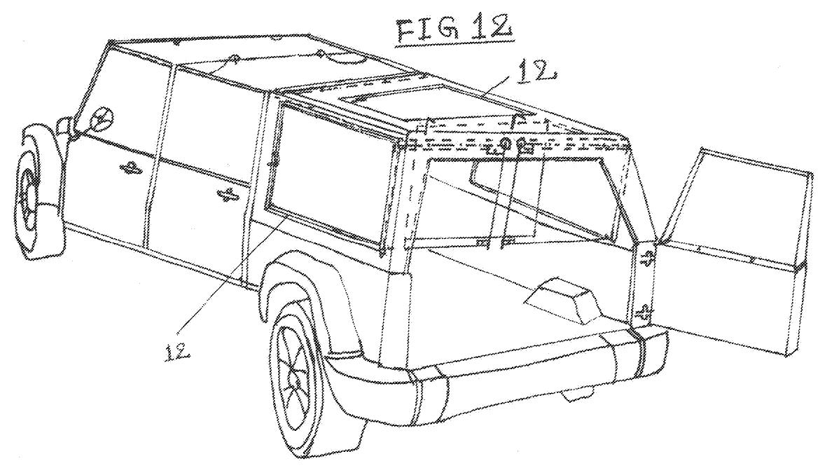

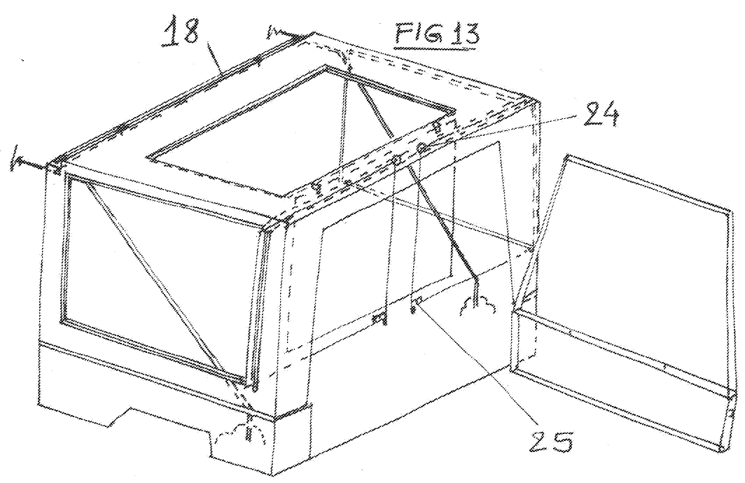

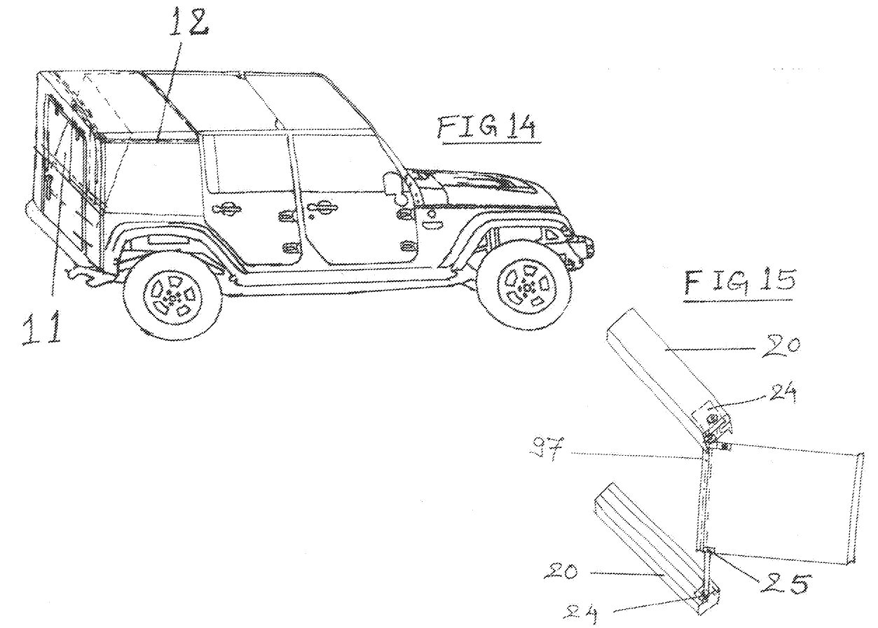

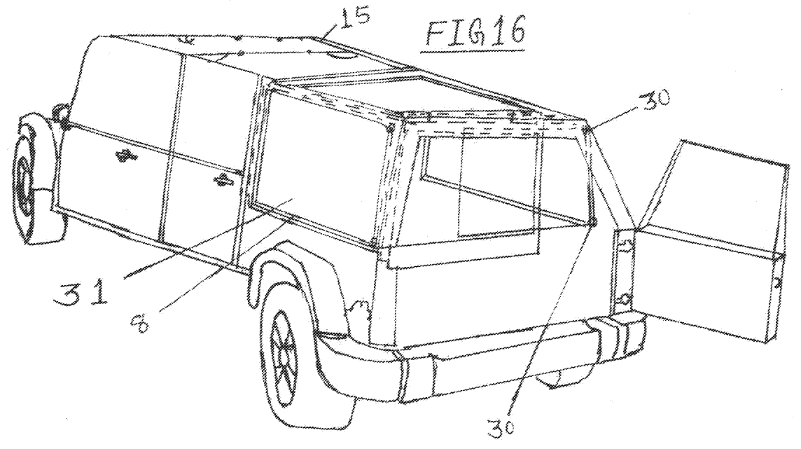

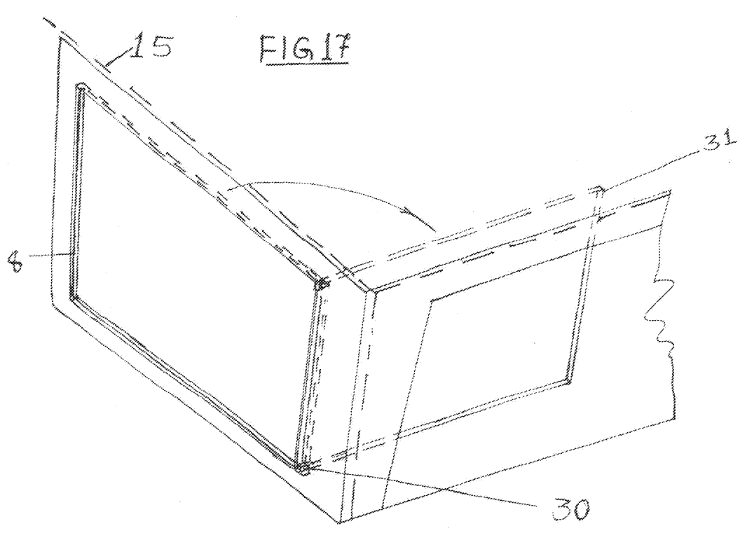

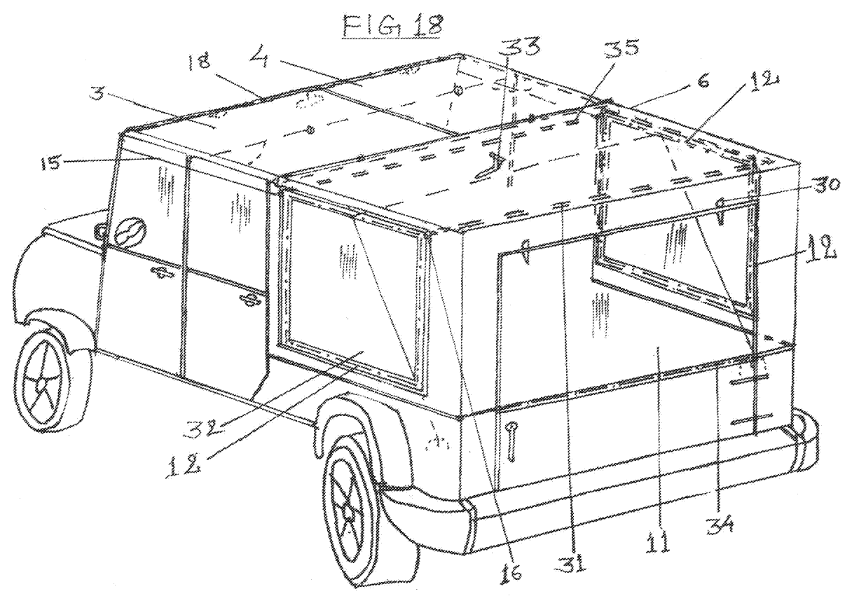

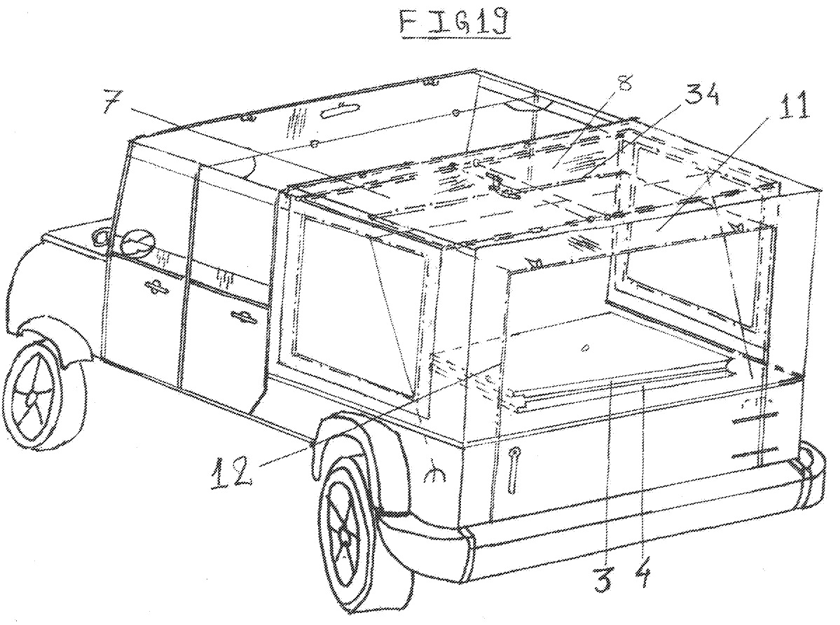

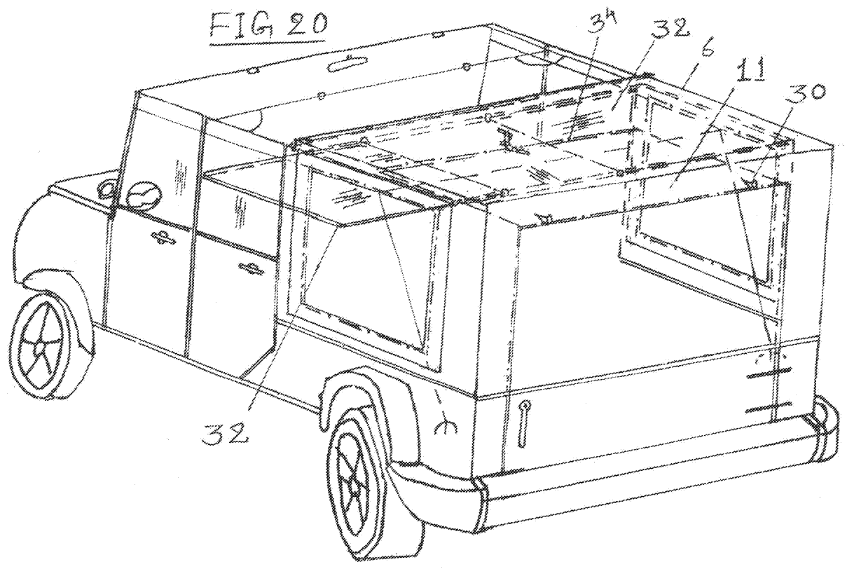

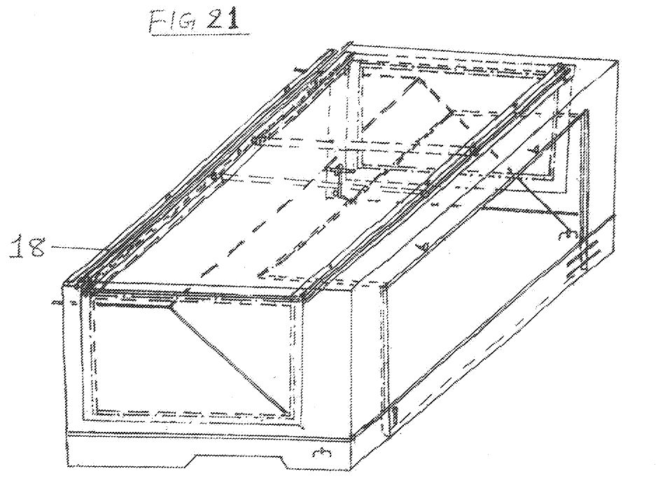

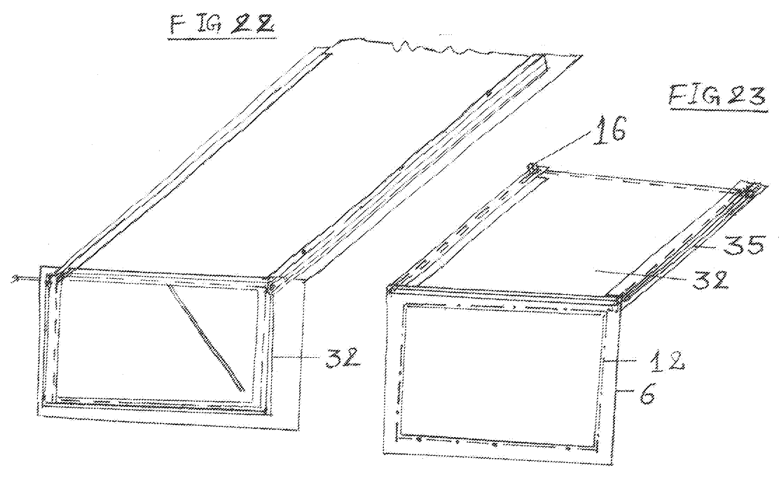

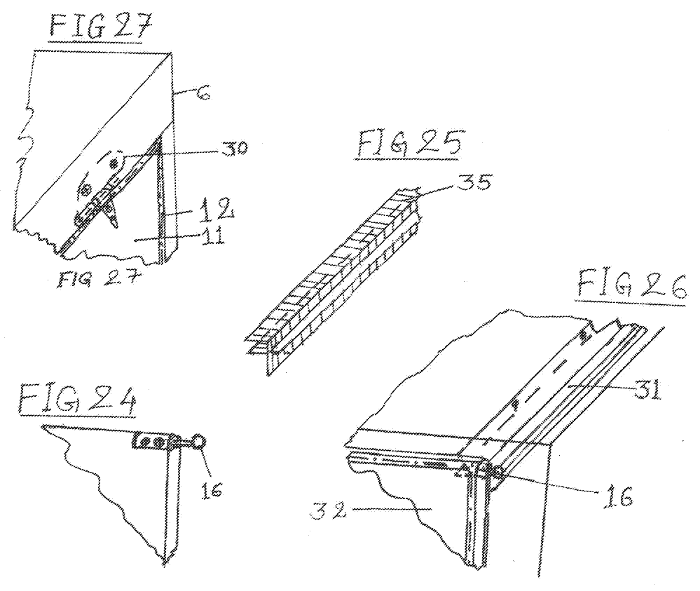

FIG. 2. present invention shown as opened at passenger area at top side and all sides of the rear cargo area of the vehicle to enjoy complete vehicle open air driving experience of the vehicle.

In FIG. 2 is shown front and rear seating area is at open position at the top of the vehicle after unlocked the latches of both Part #3 left (driver) side and part #4 right (passenger) side freedom panels at top edge of the front windshield frame of the vehicle. And unscrew and realized from part #15 roll cage pipe above front seating area and unscrew and released from part #5 openable hardtop cover from inside of the vehicle body. Part #3 left side and part #4 right side freedom panels can be stored inside at rear cargo area at rear cargo area of the vehicle while driving or parking the vehicle.

To open complete vehicle at rear side, this option can be opened at both sides and rear windows and shown in FIG. 2 as opened from the sides and rear and rotated at 270 degrees outside and set above the openable hardtop roof.

as Part #7 Left (driver) side window with frame relates to part #9 short hinges which installed above left top edge of hardtop and shown as opened window with its bottom edge at left side window frame of hardtop and its rotated about 270 degrees upside and lie down horizontal above the top of the hardtop at left side of the vehicle.

Part #7 right side glass window with frame relates to part #9 short hinges which installed above right top edge of hardtop and shown as opened window from right side of the vehicle and rotated about 270 degrees outside and placed above hardtop cover on right side of the vehicle,

Part #8 is rubber sealing part showing at inside edge of both side window frame of open hardtop

After both side window frames is opened from sides and set above both side top of the openable hardtop user can open Part #11 rear glass window which connected with Part #13 tall hinges above the rear top edge of hardtop and shown as opened from its bottom edge at rear window of the vehicle and rotated outside about 270 degrees upward and set above both left and right-side window frame already set above openable hardtop roof.

Rotating lock is shown locked to the bottom edge where part #22 rubber sealing part installed at bottom edge of rear window frame so any of the window frame do not open while driving the vehicle.

These all openable features make vehicle completely opened at passenger area and all sides and rear windows opened to enjoy complete open air and clear view driving experience of the vehicle.

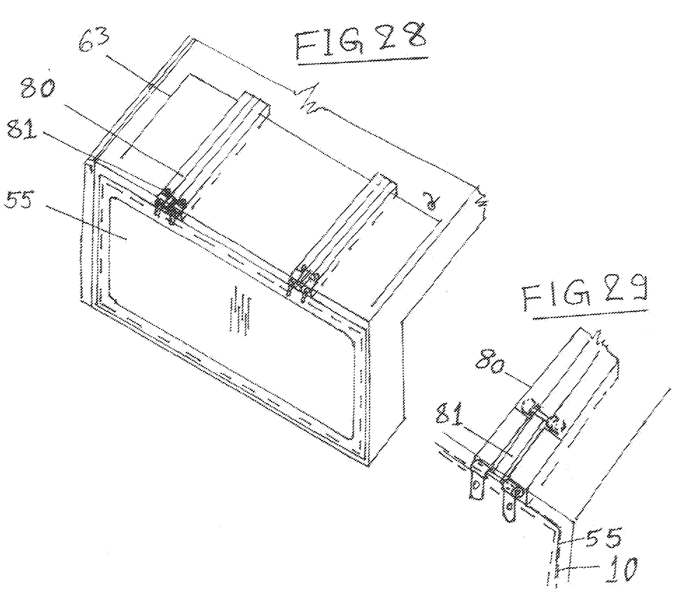

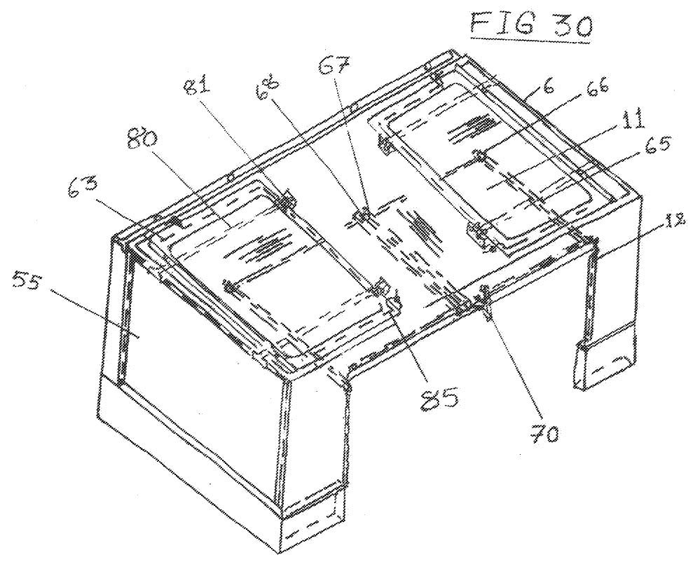

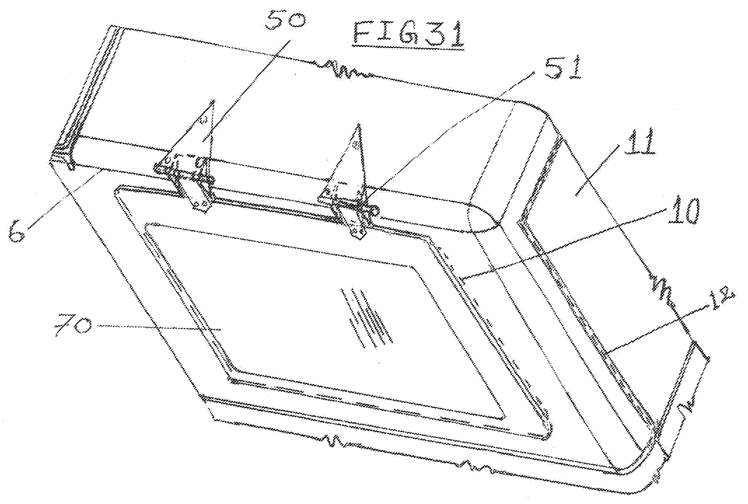

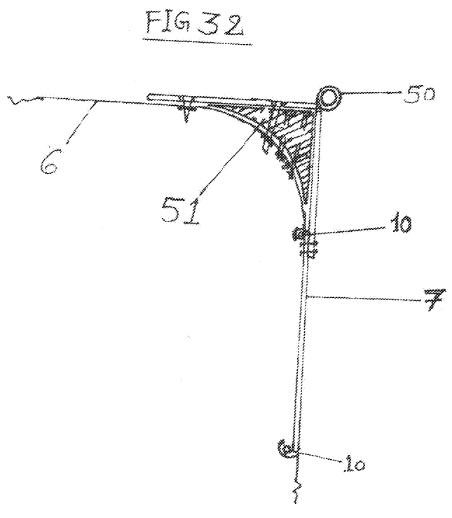

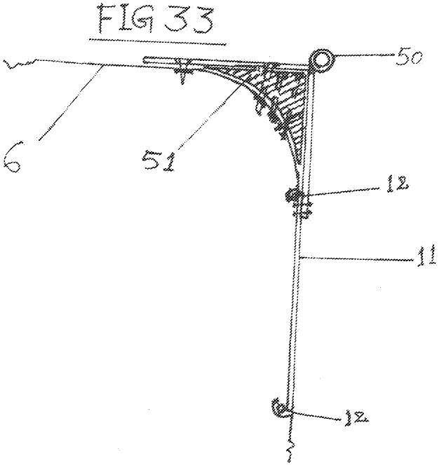

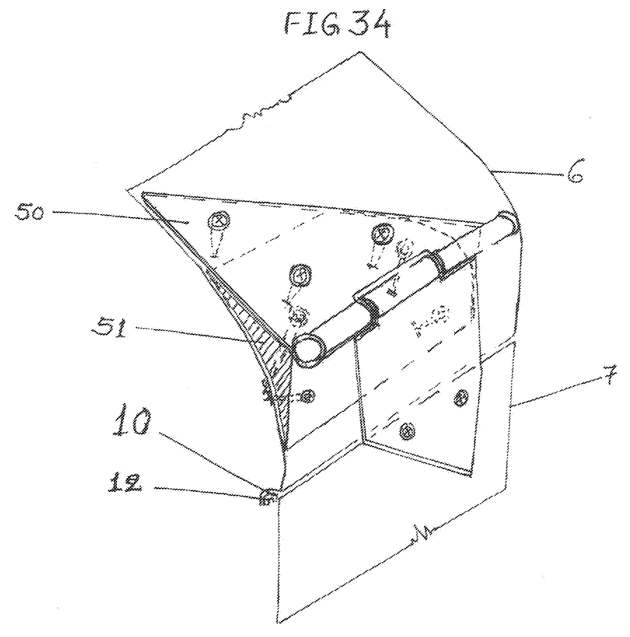

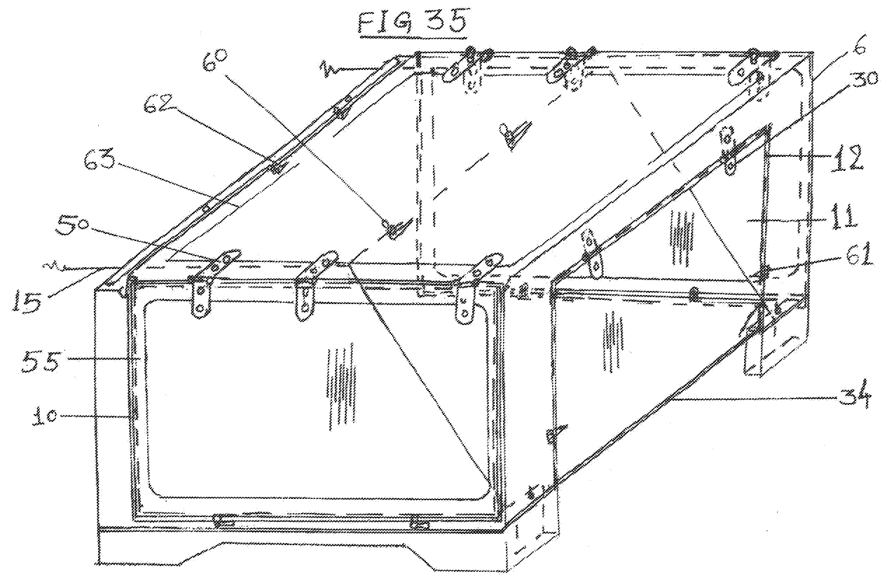

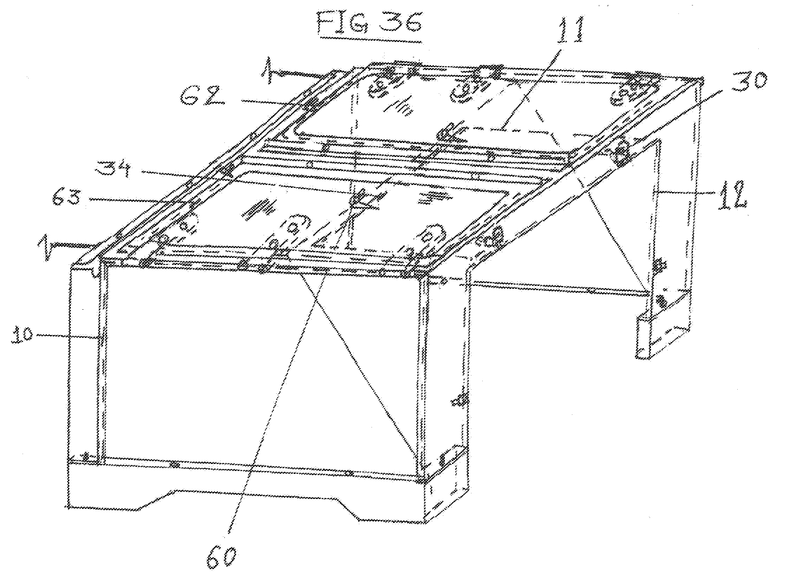

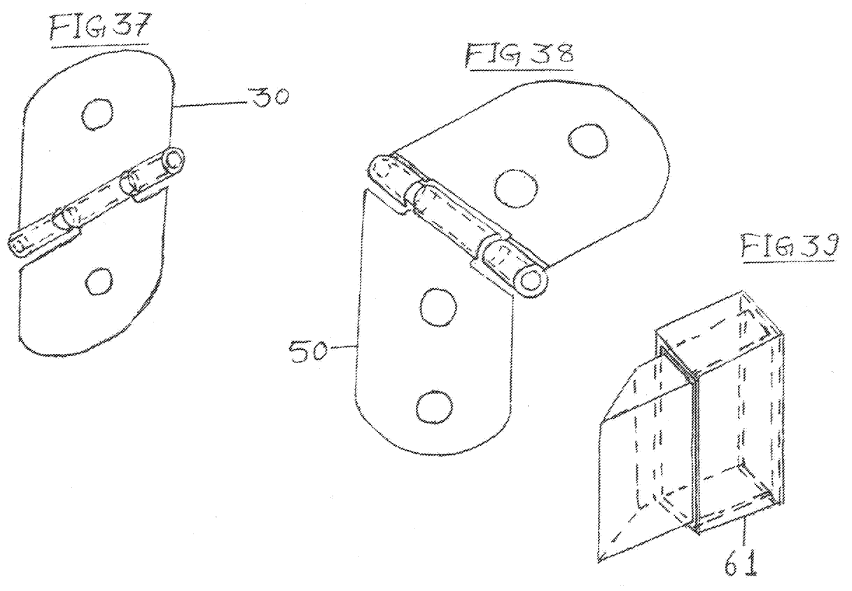

In FIG. 3 is shown as removed from left side has part #18 weather strip installed at bottom side edge which seal with top of the front wind shield

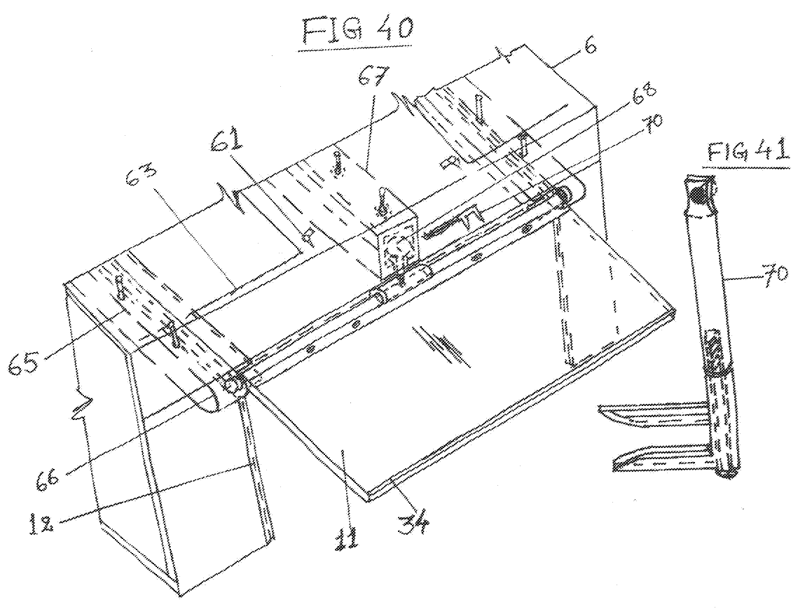

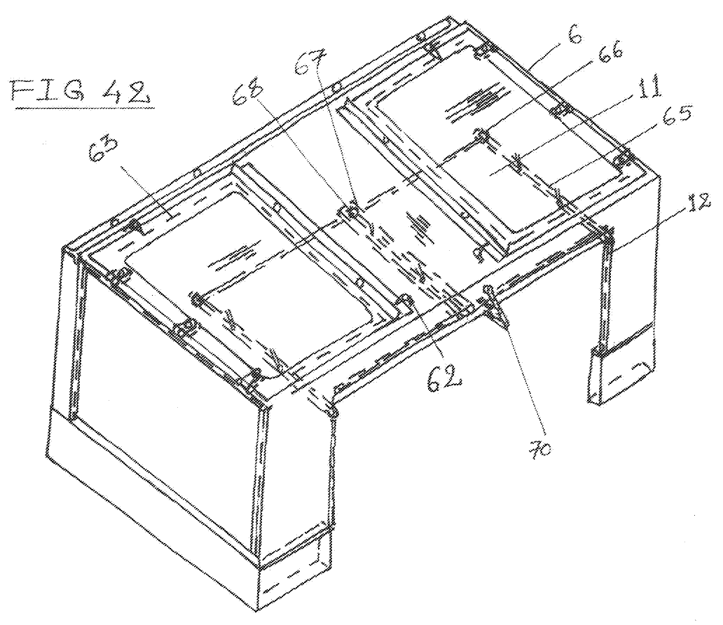

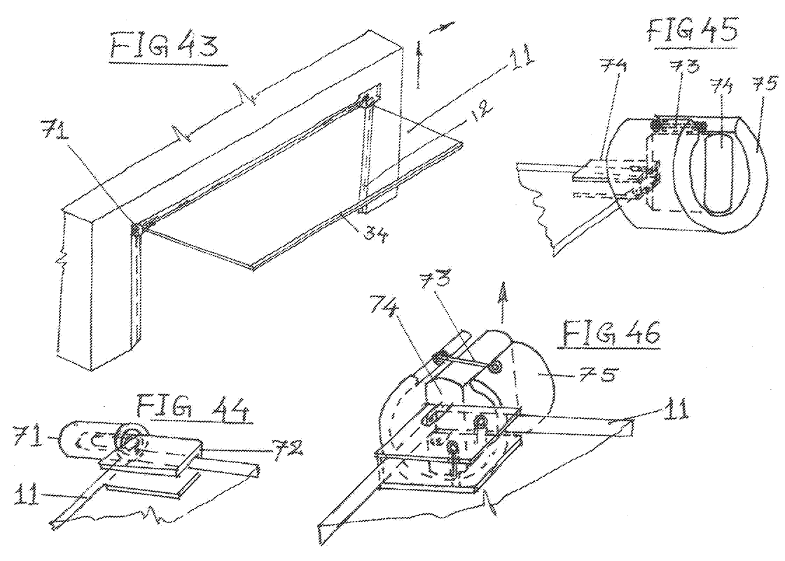

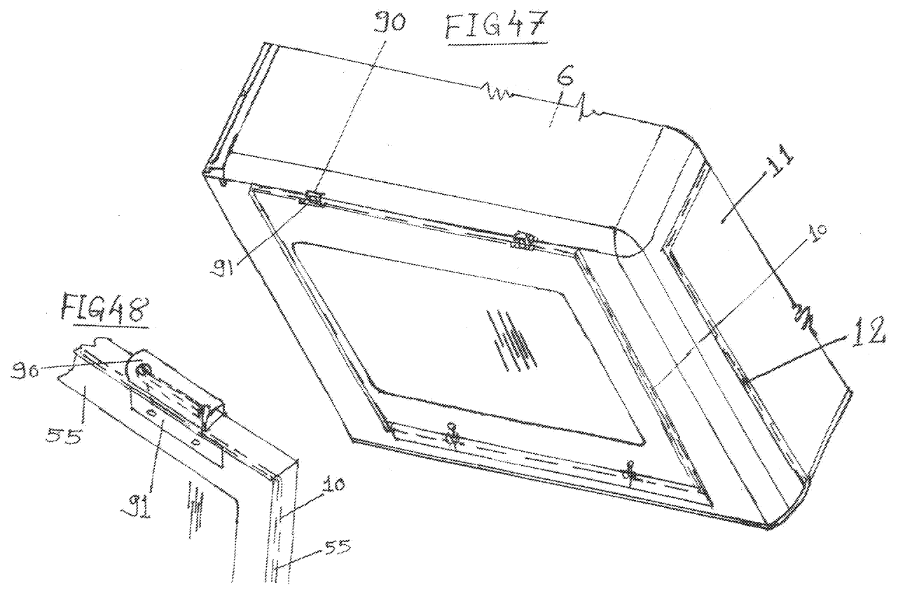

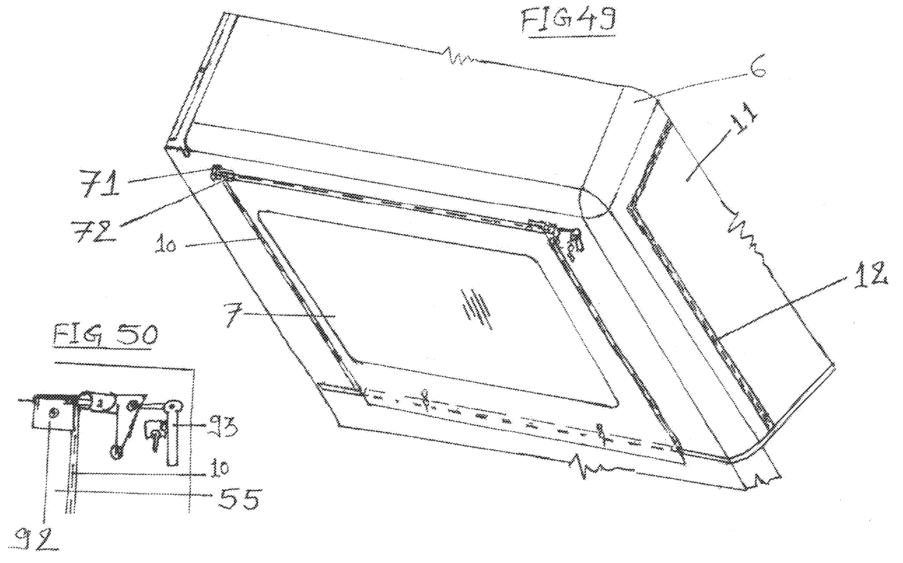

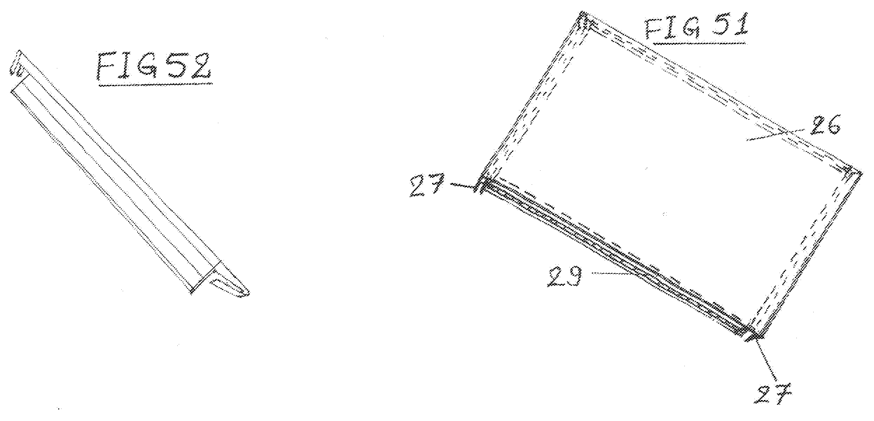

FIG. 4 shown as removed from right side top of passenger area of the vehicle has part #18 weather strip installed at bottom side edge which seal with top of the front wind shield and part #19 weather strip installed above the left side slot on top side where left side of part #3 freedom panel seal when it closed above the vehicle.

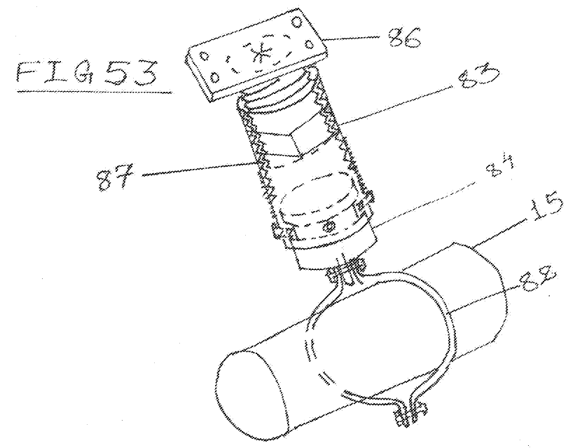

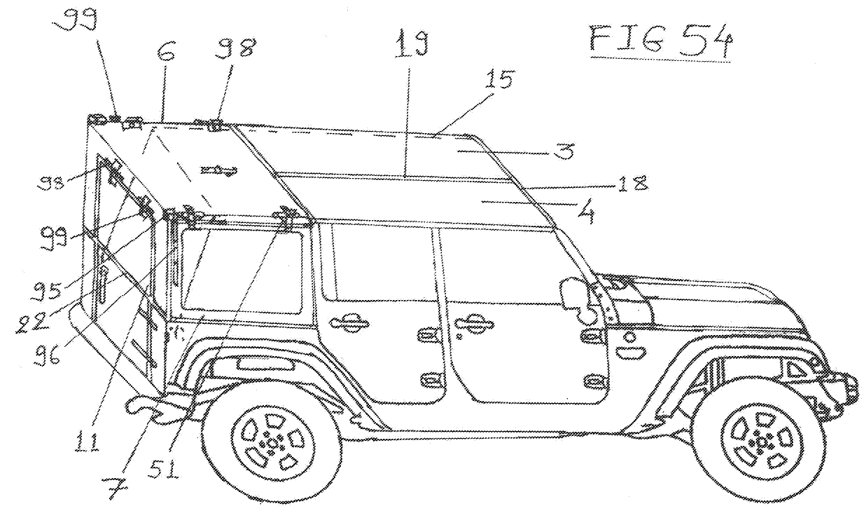

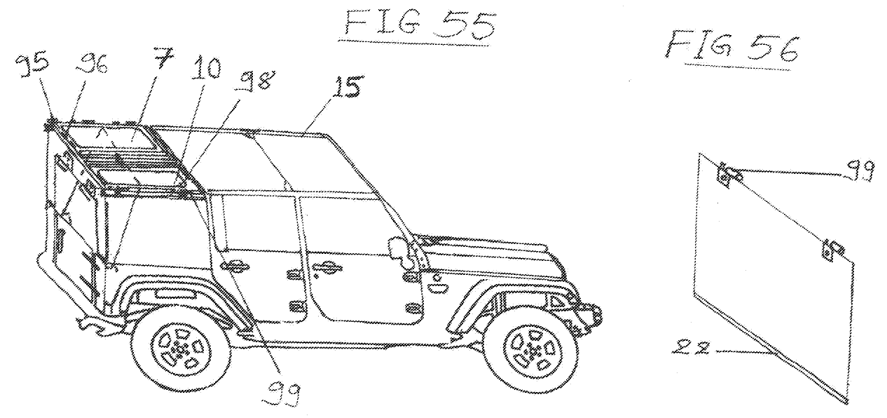

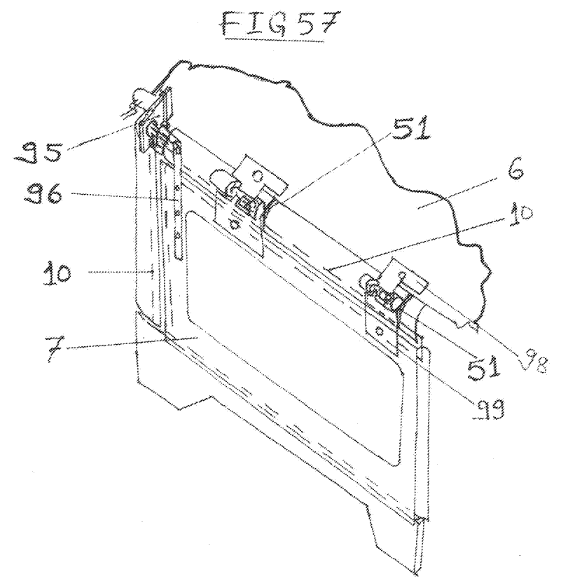

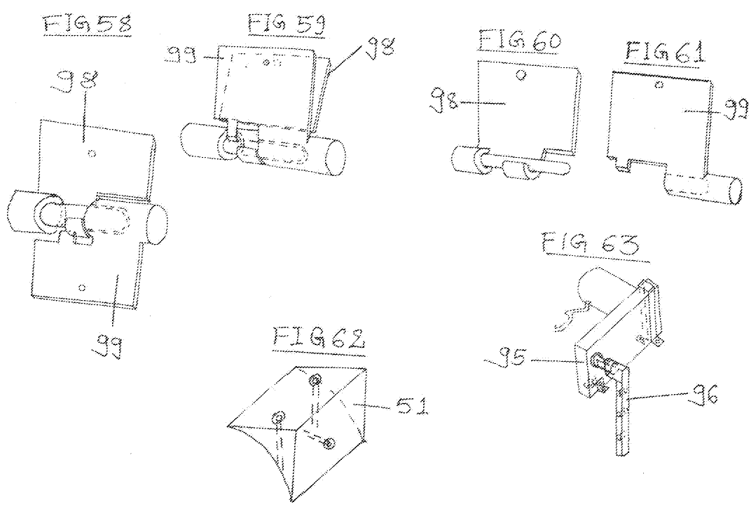

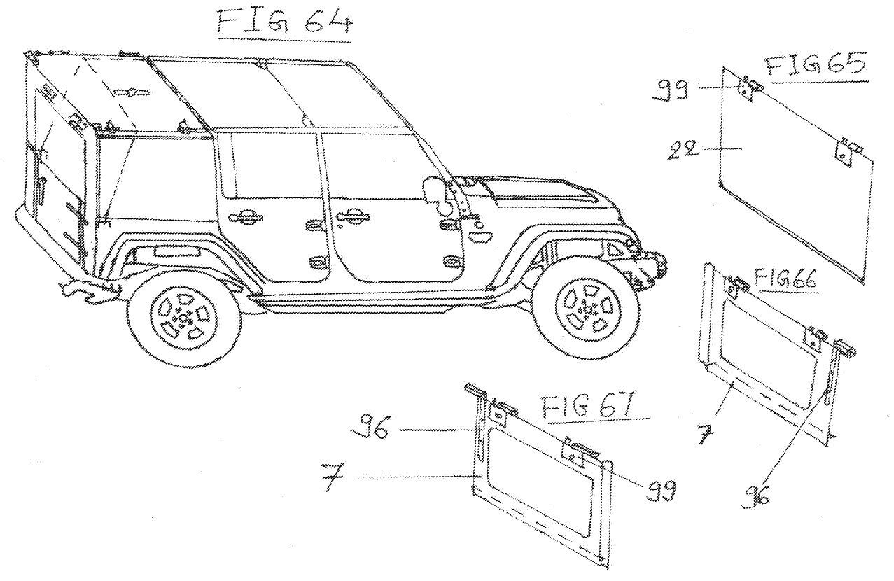

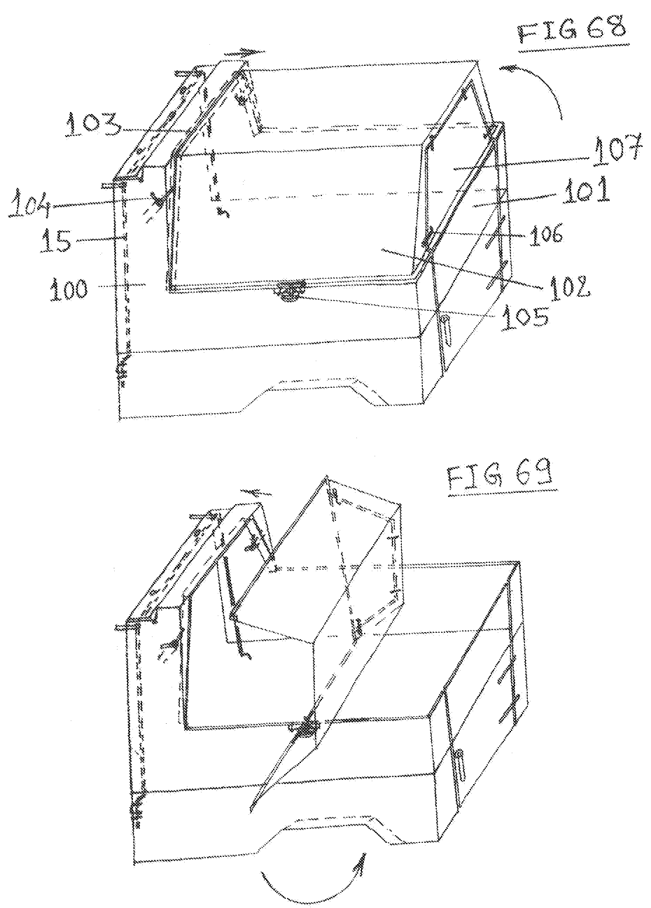

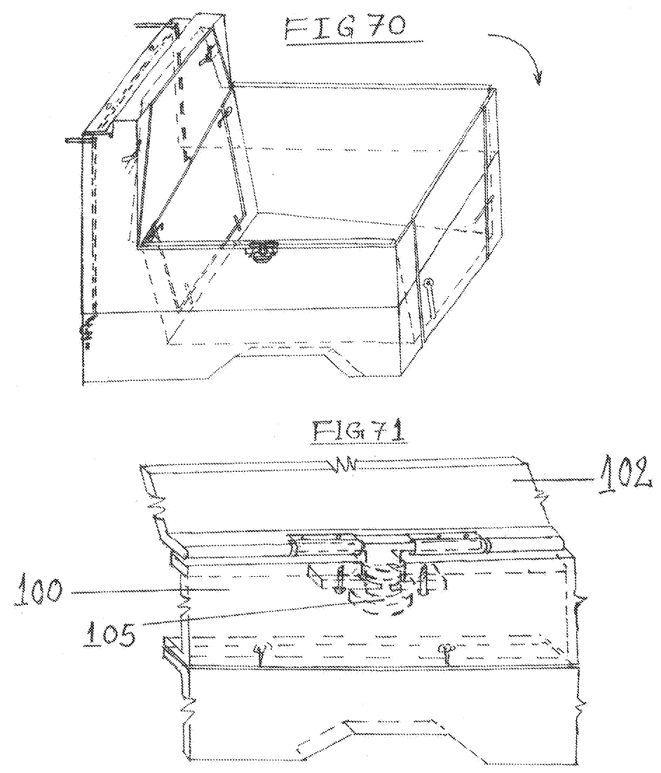

FIG. 5 is enlarged image of the rear cargo area top cover

Now in FIG. 6,7,8,9, and 10 is showing 1^{st} option to close and open rear cargo area to make as designed.

In FIG. 6 is a perspective view showing common for all for passenger area left and right-side freedom panels can be close at top as to make Option 1 model for rear cargo area and all parts numbers are similar as shown in FIG. 7 with description.

But in this option 1 has top and side windows or rear cargo area can be open outside and can be set behind the rear glass window vertically parallel, showing the present invention is installed above the vehicle and showing entire vehicle is closed with freedom panel at front and rear seating area at top side and closed left (driver) side and right, (passenger) side window and this option has additional top window above the openable hardtop cover is shown closed

and rear window at rear is also shown as closed.

FIG. 7 is a perspective view, showing 1st option to open in rear cargo area.

present invention is opened at front and rear seating area at top of the vehicle and removed both left and right freedom panels and part #37 both left and right side windows are attached with part #41 short hinges and its opened outside from its front edge towards rear and rotated horizontally about 270 degrees and set behind rear window.

Top window attached with Part #42 long hinges is opened outside front its front edge after released from its rotate lock, and rotated about 270 degrees towards back and set parallel behind rear glass window.

Rear glass window will stay closed while rest of three window is hanging behind rear as opened and rotated behind the rear glass and set on back of the openable hardtop cover frame. part #40 rubber sealing part is installed at inside edge of all side and top window frames for weather protection when windows closed

FIG. 8 is enlarged view of left side window is attached with Part #41 small hinges are installed at rear left edge of the openable hardtop frame of the rear cargo area

FIG. 9 is enlarged view of part #42 long hinges installed above the top rear edge of the openable hardtop frame of the rear cargo area with rear edge of the top glass window

Window can be open from its froth edge outside, rotate towards back and can be set behind rear glass window parallel behind if both side glass window also opened.

FIG. 10 is Enlarge view of part #39 rotating locks can be installed at front edge and can be installed on rest of the edges of the glass windows for pressure lock as per it has rising slop at its inside surface as it rotates so give pressure on glass windows to tight with rubber sealing installed on window frame for weather protection.

Now in 2^{nd} option is showing as to make model with several options to select in FIG. 11 to 30

In FIG. 11 both left and right-side freedom panel can be close or open and remove from front and rear seating area top and both rear side glass only can be open at front edge and insert inside of the rear cargo area of openable hardtop and top glass can be close or open and hang inside of openable hardtop.

In FIG. 11 vehicle is shown closed at front and rear seating area with part #3 left and part #4 right side freedom panels at top and rear cargo area hardtop is closed with left and right side glasses Part #14 and it has hanging channel part #20 is inside of vehicle at top side to support and hold both left and right side glasses when its opened and can be inserted by pushing manually inside the vehicle.

At top of hardtop it is showing closed with part #21 top window with additional option of open inside the vehicle and closed at top surface of the hardtop. Part #17 Rear glass window frame is permanently fixed above the rear door and shown complete door with frame is opened. Some of the parts is explained in FIG. 12 and FIG. 13 descriptions

In FIG. 12 showing vehicle is opened at front and rear seating area at top of the vehicle and removed both left and right-side freedom panels and it can be stored on floor of rear cargo area.

At hardtop above, rear cargo area Part #14 both left and right-side window glass are opened from front edge with released latches and rotated to back horizontally at 90 degrees rear side.

As it is fastened by Part #24 sliding knob at top rear edge corner and Part #25 Holder at bottom rear edge corner of glasses. once it both of left and right side clear glasses are opened it can go inside hanging with part #24 sliding knob through a support channel is hanging from top of hardtop inside both hardtop window frames and other end edge stay a little out at rear edge of both side of window frames. so in opened position both rear glass will hang under support channel is showing hanging inside of rear cargo area. Part #8 a rubber channel is installed at inside edge of both side window frames of the hardtop for weather protection when windows are closed.

Part #21 top glass at top of openable hardtop it showing opened from top of the hardtop and it hang with support of hinges installed at inside top surface of hardtop by opened its front side edge released from top window frame of the hardtop and hang ahead of 2 side glasses parallel showing in rear cargo area of FIG. 12. Rear glass installed door with frame is shown opened. But when rear door will have closed all glass windows will set parallel of each other. Part #23 is a weather strip installed on rear window frame

In FIG. 13 showing enlarged Image of hardtop cover at front slot is opened, both side glasses are opened and hanging inside of the rear cargo area in part #20 hanging support channel with part #24 sliding knob at top corner of rear edge of the glass and part #25 is holding knob installed at bottom corner at rear edge of the glass at bottom to enclose glasses when windows need to be close at sides of the hardtop.

Left and right-side glass windows is hanging with sliding knob inside with Part #20 a support channel installed under top of hardtop inside and its ends at both hardtop window frames. Glasses hang little out at rear edge of both side of window frames. so in opened position both rear glass will hang under support channel is showing hanging inside of rear cargo area. Part #8 a rubber channel is installed at inside edge of both side window frames of the hardtop for weather protection.

And part #21 top glass is opened and hanging inside of rear cargo area ahead of both side glasses. Both side glasses and top glass is clear. So, each of is shown clear as through clear vision view. Part #8 rubber channel is showing at inside edge of topside frame of hardtop.

In FIG. 14 is showing as to make option 2 for rear cargo area.

Shown as top part #3 and #4 freedom panels is removed from the top and both side windows shown as opened from front to rear side and slide inside and it has additional support at the bottom edge corner same as top part #24 sliding knob which can be slide inside the part #20 bottom channel which needed to be set back and front as per the length of both side windows on existing jeep type vehicle. in this FIG. no, additional top window is installed for clarity of the drawings to explain Part #97 vertical plate support is attached with inside edge of both side window's rear vertical edge to close tight with weather strips for weather protection. Part #12 weather-strip is also installed at top inside edge of rear cargo area hardtop frame. in this view additional window on rear cargo area top is not shown sad described for clarity of the drawings. Part #25 is holding knob fixed at rear bottom corner which attached with extension rod with part #24 sliding knob at bottom side

FIG. 15 is an enlarged image showing only how the one of the side window is hold by top and bottom side with part #20 channel with part #24 both top and bottom ends, so it will not tilt or rattle while driving the vehicle and will not touch any surface of the other side window.

Now in 2^{nd} option as shown in FIG. 16 and FIG. 17 for rear cargo area to make.

Both part #31 side windows can be open automatic with motor or manually inside with horizontal direction rotated toward rear glass and will hang with top and bottom part #30 rotate hinge will stay at rear edge of side window frames and its front edge will hang inside of the openable hardtop in rear cargo area

This feature only can be installed if Part #15 roll cage pipe is not in rear cargo area or it must need to be cut above rear seating area and add vertical supportive pipe at sides of rear seat for safety and remove from rear seating area.

2 door Jeep has rear seat in rear cargo area, so when open the side glasses and top window glass, rear seat need to be folded down to base seat while opening the window inside, once window reached at rear end seat can be opened to seat. so, if roll cage pipe is removed from rear cargo area then angle of metal can be added at rear end both rear corner vertically and one horizontal connecting both of inside of hardtop cover for safety if required to.

In FIG. 16 Shown both left and right-side freedom panels are opened at front and rear seating area at top of the vehicle and removed both left and right-side freedom panels and it can be stored on floor of rear cargo area.

At hardtop above, rear cargo area Part #31 both left and right-side window glass are opened from front edge with released latches and rotated inside to back at 90 degrees rear side inside of the rear cargo area either by powered motor or manually.

As it is fastened by Part #30 Rotate hinge at top rear edge corner at top and bottom rear edge corner of glasses, once it both of left and right side clear glasses are opened inside of rear cargo area it will hang with both rotate hinge stays attached at top and bottom rear edge corner of window frames. so, in opened position both side glass showing hanging inside of rear cargo area. Part #8 a rubber channel is installed at inside edge of both side window frames of the hardtop for weather protection.

Part #21 top glass at top of hardtop it showing opened from top of the hardtop and it hang with support of hinges installed at inside top surface of hardtop by opened its front side edge released front top window frame of the hardtop and hang ahead of 2 side glasses showing in rear cargo area of FIG. 10. Rear glass installed door with frame is showing opened.

In FIG. 17 shown with enlarged image of one of left side glass of openable hardtop cover is opened and hanging inside of the rear cargo area with part #30 rotate hinge showing at top and bottom corner edge of window frame at rear side.

In FIG. 18,19,20,21,22,23,24,25,26 and 27 is showing 2nd option in perspective view with rear cargo area to open all windows on openable hardtop cover to make as user's requirements

In FIG. 18 is showing the present invention 2nd option to make with openable windows installed above the vehicle and showing entire vehicle is closed with freedom panel at front and rear seating area at top side and closed left (driver) side and right (passenger) side windows and rear window at rear at rear cargo area.

All part # descriptions explained in FIG. 18 to FIG. 27

In FIG. 19 shown perspective view is showing the present invention is opened at front and rear seating area at top of the vehicle and removed both left and right seating area freedom panels and both of the side windows is opened and inserted by pushed manually inside in Part #35 support channel under the top of the rear cargo area so both of the side glass will set horizontal in c shape channel under the roof and Part #11 rear window is opened front its bottom edge inside rotated upward and locked by part #33 holding lock installed wider hard top at top of the vehicle.

In FIG. 20 Shown a perspective enlarged view of the present invention has part #6 is an openable hardtop cover frame installed above rear cargo area and installed permanently. It is installed above top edge of both side of the rear cargo area of the existing Jeep type vehicle.

The top horizontal frame at front has a slot to give support and tightening through hole from inside to hold part #3 and part #4 left sides and right freedom panel respectively.

front top surface slot above this hardtop Part #18 a rubber sealing channel is installed above the top side above bottom slot when freedom panels end rest and tighten with screws to seal both bottom of the part #3 and part #4 left and right-side freedom panels respectively to protect water leakage inside of the vehicle

Part #6 has horizontal slot at bottom rear end corner for water drainage to protect rain water enter between vertical rear end edge of both freedom panels at top of the vehicle.

Above the top edge of openable hardtop cover one slot is for holding additional part #26 soft top cover to insert part #28 to tight soft top when both freedom panels above both passenger area not installed above the top of the vehicle for clear view driving experience.

Part #32 Left (driver) side window glass relates to part #16 rivet hinges at top corners which installed above top front and rear edge of glass window.

in FIG. 20 showing window glass shown as opened upward outside about 90 degrees from its bottom edge so made in horizontal position and inserted by pushing manually half only in Part #35 c shape channel so glass window is shown half portion is still hanging out at left side of the vehicle.

Part #35 C shaped channel has horizontal slot on front and rear side wall to insert and hold Part #16 rivet hinges toward front and rear. And Part #32 Right (passenger) side glass window with frame relates to part #16 rivet hinges which installed above right top front and rear edge of glass and shown as opened window from right side of the vehicle is opened upward from its bottom edge and completely inserted inside part #35 c shaped channel placed under hardtop cover on right side of the vehicle.

Part #12 is rubber sealing part installed at inside edge of both side window frame of open window hardtop for weather protection.

Part #11 rear glass window relates to Part #30 hinges above the top edge of rear glass window at inside and fixed with inside edge of hardtop frame, and glass window can be opened at rear window frame of the vehicle opened inside upward lifted from its bottom edge and made parallel under right side glass window and can be locked with part #33 holding lock which installed under top surface inside of rear cargo area.

part #12 rubber sealing part installed at inside edge at both sides and top edge of openable hardtop frame for weather protection.

Part #34 rubber sealing part is installed at bottom edge of rear glass window for weather protection. It sealed tight with top inside edge of rear door when door closed.

In FIG. 21 Shown perspective enlarged view of only openable hardtop rear cargo area frame structure Both left and right-side windows shown as open position and both glasses are completely inserted in Part #35 c shaped channel. Rear glass window shown opened inside and locked by holding lock hanging from top of openable hardtop frame.

Also, shown Part #18 rubber sealing part is installed above bottom slot at front throughout left to right for weather protection when part #3 and #4 left and right freedom panels are installed above the top.

vehicle has open window option to insert inside of vehicle in c shaped channel and additional feature is rear glass window can open inside and locked inside of vehicle and bang with holding lock.

As per shown in FIG. 22 perspective enlarged view of only part #32 left side window is at closed position above the openable hardtop cover frame. Part #16 Rivet hinge is installed inside slot end of part #35 c shaped channel at both front and rear side top corners at left side of the vehicle.

C shaped channel installed both front and rear side throughout to the right-side window

And it has countersink holes at top surface from inside to fix screws upside with under surface of openable hardtop cover frame. Part #15 roll cage pipe is shown as it comes up with factory installed on jeep type vehicle.

As shown in FIG. 23 perspective view of left side window frame of openable hardtop frame glass window is opened upward and inserted completely in part #35 c shaped channel with showing its bottom edge at top of the window frame. it's rivet hinges are in middle of the c shape channel.

Part #12 rubber sealing part is showing above the frame for weather protection.

In FIG. 24 is enlarged view of top left corner of the left side glass window. Part #16 rivet hinge is showing installed with screws above top left corner of the glass window as shown in drawing. Also, installed on front edge top corner for hold the glass at front side.

In FIG. 25 is showing only Part #35 c shape channel installed under the roof of openable hardtop cover frame. front c shaped channel is open towards rear and rear c shape channel is open towards front.

It has long horizontal slot as shown in FIG. 25 in vertical wall to pass rivet hinge through it

it is in C shape and its top surface has some countersink holes inside towards top to fix screws under the roof of openable hardtop cover frame.

Bottom surface is only beginning after surface of glass touch inside at both Left and right side end. so, in beginning at both ends c shape channel is inverse L shape to make glass vertical when it is closed above the outside frame of hardtop

Bottom surface is to hold the left and right side glass when vehicle is opened at side windows of the frame and inserted inside parallel to top surface roof.

So, top surface is to fix the channel with top surface of hardtop

Front and back vertical surface has slot for pass through rivet and hold the rivet

And bottom surface of c channel is to support the glass when openable hardtop window is opened and glass is inserted in it

As shown in FIG. 26 enlarged image of rear top edge corner of glass window as closed position at left side of the open hardtop cover frame. Rivet hinge is inserted in slot of vertical wall at both front and rear side of part #35 c shaped channel.

As shown FIG. 27 enlarged image of rear glass window and it top right-side edge has Part #30 hinges installed front inside wall of the glass. Hinges are attached inside at downside edge window frame of openable hardtop cover frame. So, it can be open inside of rear cargo area. Glass is shown as closed position on frame.

as in FIG. 28 is shown as to make 2^{nd} Option type of model as shown left side window is closed above the frame.

Side glass window frame is attached with Part #81 I shape hinge shaft at top side edge corner of hardtop

part #81 I shaped hinge shaft is above the top corner and its other end is attached inside of part #80 upside open C shape channel installed inside of top surface of the rear cargo area hardtop cover.

there is part #63 rubber cushion installed above the top surface of hardtop where both side windows can be set above it.

FIG. 29 is show n enlarged sketch of left side window frame is attached with Part #81 and another end of I shape Part #81 is inside of Part #80 Upside open C shape channel.

this I shape hinge shaft has both ends as perpendicular as circular shaft so when glass window frame will be opened from frame of hardtop its can be lift little up above the upside open C shape channel so complete side window frame can be slide above the surface of the hardtop cover.

if roof rack is installed above the top surface than this open and slide above surface of the hardtop option can be use.

In FIG. 30 is shown option 2 as complete rear cargo area both left and right-side window frames are opened and slides above the top surface of the-rear cargo area hardtop and its locked by part #85 latch lock to hold side window frame as fixed and it has part #63 rubber cushion between window frame and hardtop cover, so it will not make rattling sound.

Rear glass window part #11 is shown as open and inserted inside of rear cargo area through its both side end in c shaped channel and holds by its extended C shaped frame inside and its top center edge ball point hinge is slides inside in downside open C shape channel. bottom edge of rear glass window is locked by part #70 F shape lock is rotated down and its half top F portion is rotated inside of cargo area, so bottom edge of glass window is in gap of F shaped knob will stay fixed and center of top edge of glass will hold by downside open C shape channel inside of rear cargo area so cannot make rattling sounds while driving the vehicle.

Now in additional on 3^{rd} Option is for if curved shaped rear cargo area is made or if required to make conversion on existing this type of curved shape top covers then this is additionally designed hinge support required to make hinge exactly fit and give solid support to the hinge above curved surface of rear cargo area top cover if Option 1 and Option 2 or any model has rear cargo area top corner is designed to make curved shape for aerodynamic force decrease and better look at top side edge and rear top corners edge of rear cargo area hardtop cover to top edge corner at side on Option I model and rear side edge corner and rear top edge corner in option 2 to install hinges to open side and rear glass windows or top glass window down towards rear behind rear glass.

As shown in detail with part descriptions in drawing in FIG. 31,32, 33 and 34 to add on if any option model made curved shape rear cargo area hardtop at both top side upper corner

FIG. 31 Shown left driver side of the rear cargo area has additional designed part #51 hinge support required to make hinge exactly fit and give solid support to the hinge above curved surface of part #6 rear cargo area top cover if Option or any model has rear cargo area top corner is designed to make curved shape for aerodynamic force decrease and better look at top side edge and rear top corners edge of rear cargo area hardtop cover commonly current available models are look like in this FIG. 31 is top corner edge where vertical and horizontal surface meet at top corner is made curved shape so to install part #50 Hinge for side and rear glass windows to open or close is with solid support additionally designed part #51 curved support has bottom surface is required to make similar curved shape of aluminum or wood type solid material to install surface to surface with top edge curved shape of hardtop cover. This curved shape support has top surface and side surface is fiat surface so its top and side surface make right angle to support hinge. Curved support has V shaped countersink at surface and through holes through which long bolt can pass through and those bolts inserted in trough holes of curves shape corner of hardtop cover and tightened with bolt from inside surface of hardtop cover to make solid support to install hinges. Part #50 hinges have some extra holes to pass screws to insert in solid curved support and some holes goes direct inside of rear cargo area hardtop cover at the end portion of hinges. And at other end of hinge towards downside end bolts are installed with side glass frame.

As shown in FIG. 32 rear view of one side of the rear cargo area has additional designed Part #51 hinge support required to make hinge exactly fit and give solid support to the hinge above curved surface of part #6 rear cargo area top cover if Option 1, 2 and 3 and as rear end vertical side end or any model has rear cargo area top and rear end corner is designed to make curved shape for aerodynamic force decrease and better look at top side edge and rear top corners edge of rear cargo area hardtop cover in currently available models are look like in this FIG. 32 is top corner edge where vertical and horizontal surface meet at top corner is made curved shape so to install part #50 Hinge for side and rear glass windows to open or close is with solid support additionally designed part #51 curved support has bottom surface is required to make similar curved shape of aluminum or wood type solid material to install surface to surface with top edge curved shape of hardtop cover. This curved shape support has top surface and side surface is flat surface so its top and side surface make right angle to support hinge. Curved support has V shaped countersink at surface and through holes through which long bolt can pass through and those bolts inserted in trough holes of curves shape corner of hardtop cover and tightened with bolt from inside surface of hardtop cover to make solid support to install hinges. Part #50 hinges have some extra holes to pass screws to insert in solid curved support and some holes goes direct inside of rear cargo area hardtop cover at the end portion of hinges. And at other end of hinge towards downside end holts are installed with side glass frame. Part #10 is weather strip to seal part #7 glass when it is closed position for weather protection.

This hinge support installed in vertical curves shape above top curved shape if option 1 model made to open side windows go above the top surface of the rear cargo area hardtop. Hinges are installed down end vertical and up end horizontally install above hardtop cover as shown in FIG. 31 and 32

This same hinge support can be installed in horizontal curved shape if option 1 model made to open side windows to go behind rear glass window of rear cargo area. Hinges must be installed both ends in horizontal position as one end to the side and one end to the rear side of the hardtop tike shown in FIG. 6 and 7 regular part #41 hinges are installed at rear edge vertical corner at right angle shape model and if vertical corner is made curved shape than part #51 curved support will go under the part #50 hinges to get solid support with curved shaped hardtop surface.

As shown FIG. 33 as enlarged side view of rear side of the rear cargo area has additional designed Part #51 hinge support required to make hinge exactly fit and give solid support to the hinge above curved surface of part #6 rear cargo area top cover if Option 1 or any model has rear cargo area top corner is designed to make curved shape tor aerodynamic force decrease and belter look at top side edge and rear top corners edge of rear cargo area hardtop cover in currently available models are look like in this FIG. 33 is top corner edge where vertical and horizontal surface meet at top corner is made curved shape so to install part #50 Hinge for side and rear glass windows to open or close is with solid support additionally designed part #51 curved support has bottom stir lace is required to make similar curved shape of aluminum or wood type solid material to install surface to surface with top edge curved shape of hardtop cover. This curved shape support has top surface and side surface is flat surface so its top and side surface make right angle to support hinge. Curved support has V shaped countersink at surface and through holes through which long bolt can pass through and those bolts inserted in trough holes of curves shape corner of hardtop cover and tightened with bolt from inside surface of hardtop cover to make solid support to install hinges. Part #50 hinges have some extra holes to pass screws to insert in solid curved support and some holes goes direct inside of rear cargo area hardtop cover at the end portion of hinges. And at other end of hinge towards downside end bolts are installed with side glass frame.

Part #12 is weather strip to seal part #11 glass when it is closed position for weather protection

Height of the curved shape should be longer then curved support used in side windows as per rear glass windows will goes above the both side glass windows when in open position.

And in detail enlarge view of FIG. 34 Showing enlarged view for combine view of Part #50 hinge and part #51 curved support for side and rear side of the rear cargo area which used in Option 1 model.

It has additional designed Part #51 hinge support required to make hinge exactly fit and give solid support to the hinge above curved surface of rear cargo area top cover if Option 1 has rear end vertical side end or any model has part #6 rear cargo area top corner is designed to make curved shape for aerodynamic force decrease and better look at top side edge, rear side edge and rear top corners edge of rear cargo area hardtop cover in currently available models are similar look like in this FIG. 34 have top corner edge where vertical and horizontal surface meet at top corner is made curved shape so to install part #50 Hinge for side and rear glass windows to open or close is with solid support additionally designed part #51 curved support has bottom surface is required to make similar curved shape of aluminum or wood type solid material to install surface to surface with top edge curved shape of hardtop cover. This curved shape support has top surface and side surface is flat surface so it outside top and side surface make right angle to support hinge. Curved support has V shaped countersink at surface and through holes through which long bolt can pass through and those bolts inserted in trough holes of curves shape corner of hardtop cover and tightened with bolt from inside surface of hardtop cover to make solid support to install hinges. Part #50 hinges have some extra holes to pass screws to insert in solid curved support and some holes goes direct inside of rear cargo area hardtop cover at the end portion of hinges. And at other end of hinge towards downside end bolts are installed with side glass or rear glass frame. Part #10 and part #12 is weather strip to seal part #7 and part #11 glass when it is in closed position in FIG. 35 shown as option 1 model to make rear cargo area hardtop cover has both left and right-side glass windows with frame part #55 of rear cargo area hardtop is shown closed on side of hardtop frame at both side these both side window frames relate to one end of each 270-degree rotation hinges part #50 and its other end is attached with at top edge side corners of top surface of the hardtop of rear cargo area outside.

In this figure shown as hardtop cover part #6 has right angle top edge corners so hinge support not shown as installed but if hardtop corner edges made curved shape than hinges need to be installed with hinge support part #51 curved hinge support side window frame with glass is shown closed and set above the sides of hardtop frame which has L shape support frame little inside surface with weather strip part #10 for weather protection and to hold windows at both front and rear vertical edge and at top horizontal edge. both side window frames are extended at bottom after it's inside T shaped perpendicular frame is set above top surface of factory made body frame to support and hold hardtop cover above it. and shown it has holes to tight screws through it to stay fixed.

both window frames can be locked with through hole screws at exact location of factory made holes with threads on top edge where bottom edge of side window frames go surface to surface inside so window frames stay fixed while driving in high speed and does not make rattling sound, and its pressed well from outside above the front, rear and top edge weather strips and tighten and locked with screws inside. so, air, wind noise and water cannot enter inside of rear cargo area anytime.

In this option 3 rear glass window is shown as closed at rear side. rear side glass window is connected inside of hardtop cover frame with one end of 90 to 120-degree rotation hinges part #30 and its other end is connected at top of opening of the hardtop cover frame.

both vertical side edge and top edge of hardtop cover frame has weather-stripped part #12 installed when rear glass window is closed than its press surrounding weather-strips and glass is locked with latch lock part #61 installed at both vertical sides of hardtop cover inside. so, no air, wind noise or water can enter inside this glass window frame has weathers tip installed at bottom edge of the glass so when rear door of the vehicle is closed its press to the weather-strip so no air, wind noise or water can enter inside of vehicle.

In FIG. 36 is shown as option 3 model to make rear cargo area hardtop cover has both left and right-side glass windows with frame of rear cargo area hardtop is shown opened front its bottom edge with lifting and rotated 270 degrees to upside with support of hinges attached and set above the top surface of the rear cargo area hardtop. after opened both side windows and set above the top surface of the hardtop it can be locked with rotate latch by Part #62 latch lock installed above the top surface of the hardtop installed above the top surface of the hardtop so it stay fixed white driving in high speed and does not make rattling sound, there is part 63 installed in C shape rubber cushion both sides above the top surface so when window frames set above top surface and pressed by latch lock Part #62 it does not make rattling sound while driving, but in this option 3 rear glass window is shown opened inside from lifting its bottom edge and rotated 90 to 120 degrees inside with attached inside hinges part #30 towards up and set horizontally parallel with top surface of hardtop and its hold by latch lock part #60 is installed with top horizontal roll cage pipe and it shown looked with 2 latches installed inside with rear edge of top horizontal roll cage pipe so it stays locked while driving the vehicle.

benefit on this option 3 is only two side windows can be set each side above the top of hardtop cover surface. so, each of windows does not touch each other in this option for no scratches or frame damage worry and will not make any rattling noise while driving on high speed because of rubber cushion is installed above the top surface and if be pressed by both side window frames and will be locked while driving the vehicle, plus rear glass window will be open inside of hardtop and locked with latches at top horizontal roll cage pipe so any of the 3 windows can be open but will not touch each other while driving the vehicle for open air driving experience.

Now if obstructive large size goods are loaded in rear cargo area than rear window open inside will not convenience for users as its come-on way to open or close the rear glass inside of rear cargo area.

so, following additional option is for open and set rear glass windows as either opened outside and insert in with sliding or completely remove from the hardtop frame and store inside rear cargo area floor so in these 2 additional options still all 3 windows will not gather at one place to avoid damage or rattling noise while driving the vehicle

FIG. 37 is showing enlarged sketch of part #30 hinges can be used to connect rear glass window to make Option 3 model to open rear glass window open inside of rear cargo area, hinge can be rotate more than 90 degrees if latch lock to hold glass under internal surface of the hardtop cover.

FIG. 38 is showing enlarged sketch of part #50 to make option 3 model and similar hinge used to make also option 3 to open side windows and rotate to 270 degrees outside of the rear cargo area hard top.

FIG. 39 is showing enlarged sketch of part #61 sliding latch lock to close rear glass window in making option 3 rear cargo area hardtop window, it has rectangular shaped metal latch inside of rectangular frame which can be installed inside at rear wall of rear cargo area hardtop to lock rear glass window when it is at closed position, so weather-strip at bottom edge of rear glass window will be pressed by top edge of factory made rear door of the vehicle, so, air or water cannot be entering inside of the vehicle.

In FIG. 40 is shown option 3 as rear glass window open outside rotation from its bottom to top and as it is at horizontal position than it can be slide in part #66 roller hinge installed at both top side corner ends of the rear glass window in with C shape channel at both side in part #65. and in center at top edge of the glass part #68 ball point hinge will be slide inside of down side open hanging part #67 C shaped channel. so as per more length of rear window glass it will get strong holding support in center for top edge of the glass.

with FIG. 41 is showing part #70 F lock will give support to the bottom edge of the glass when it's at opened position. This F Lock is installed at rear wall of the rear cargo area hardtop exactly above the opening of the rear glass window and its stay horizontal while rear glass window is at closed position with roller knob above the rear wall of hardtop surface. This lock is attached at only with its through hole with screw on surface and its top C shape portion of F is can be rotate 360 degrees when it required to hold the bottom edge of the rear glass window when its opened and inserted inside of rear cargo area so while driving the vehicle in rear window as opened position, bottom edge of the rear glass window will be hold with F as down position and its top F shape plates will rotate inside so glass will be hold by its top F portion which has rubber grip in it so glass will not make any rattling noise while driving the vehicle.

In FIG. 42 is shown complete rear cargo area hardtop cover as both left and right-side windows are opened and rotated outside upward at 270 degrees and set above the top surface of the hardtop cover and its locked by part #62 latch lock fixed above the top surface of hardtop cover. there is Part #63 rubber cushion is installed above the top surface of the hardtop so when both side windows set above it and its pressed by latch lock, so it will not make any rattling sounds while driving the vehicle.

Rear glass window part #11 is shown as open and inserted inside of rear cargo area through its both side end in c shaped channel and hold by its extended C shaped frame inside and its top center edge ball point hinge is slide inside in downside open C shape channel, bottom edge of rear glass window is locked by part #70 F shape lock is rotated down and its half top F portion is rotated inside of cargo area, so bottom edge of glass window is in gap of F shaped knob will stay fixed and center of top edge of glass will hold by downside open C shape channel inside of rear cargo area so cannot make rattling sounds while driving the vehicle.

with this slide in rear glass window inside of rear cargo area as additional option will avoid any of the rattling noise or scratches issues as of setting both side windows above the top and rear glass window as opened and slides inside of rear cargo area. so, none of the windows will touch with each other's.

In FIG. 43 is shown second additional option in option 3 for rear glass window open to completely and remove as shown in figure as attached but to avoid all 3 windows gather parallel at one surface and make rattling noise or possible damage while driving the vehicle when users like to remove.

part #11 rear glass window shown as lifted outside upward from its bottom edge and made at horizontal position. its Part #74 Right shaft at top corner is lifted little up from Part #75 C shape Hinge cylinder and it can be slide little towards right side as its already tilted up out of Upside opened C shape hinge cylinder opening so Part #72 left top corner shaft can be pulled out from part #71 fixed cylinder hinge. so, complete glass assembly can be remove from hardtop cover frame and can be store inside of rear cargo area floor will make rear window completely removed to pass air from rear window frame of rear cargo area.

this option of removing rear glass window can also be made on both side windows. so, all 3 windows can be removed completely and stored inside with safe case inside of rear cargo area floor.

In FIG. 44 is shown enlarged sketch of Part #72 left top corner shaft is inserted in Part #71 fixed cylinder hinge as part #11 glass window is attached in it and rear glass as horizontal position.

FIG. 45 is showing enlarged sketch from right side of Part #74 right shaft at top corner is inside of part #75 C shape Hinge cylinder has opening at top side. rear glass window is attached with part #74 right shaft clamp and shown as glass in horizontal position. this shaft inside of hinge cylinder is made from circular road and it's both sides are trimmed so it can be pull out through C shape-opening of C shape hinge and its top and bottom circular surface can give fixed holding as shaft will be in horizontal position inside c shape hinge cylinder while glass is in vertical position as closed on the frame of the hardtop cover so complete glass assembly stay secured above the frame.

In FIG. 46 is shown as enlarged sketch view from left side of Part #74 right shaft at top corner is inside of part #75 C shape Hinge cylinder has opening at top side. rear glass window is attached with part #74 right shaft clamp and shown as glass in horizontal position, this shaft inside of hinge cylinder is made from circular road and it's both side are being trimmed so it can be pull out through C shape opening of C shape hinge and its top and bottom circular surface can give fixed holdings shaft will be in horizontal position inside e shape hinge cylinder while glass is in vertical position as closed on the frame of the hardtop cover so complete glass assembly stay secured above the frame. this technic can be applied on both side windows of rear cargo area of hard top too, to open and remove the glass from side window frames and store inside of the rear cargo area.

Now as shown in FIG. 47 and 48 if both of the left and right side windows want to remove completely, then as shown in FIG. 47 and 48 part #55 side window frame has 2 part #91 extended plate installed above the top edge which can be inserted inside of part #90 holding slot which is installed at top edge of the rear cargo area hardtop frame as shown in FIG. 47 side window frame is fixed on frame of hardtop cover below the edge of window frame part #10 weather strip will be pressed to give weather protection when it's at closed position. so when if need to open, 2 screws need to be removed from the inside at bottom edge of side window frame which is fixed with factory made top surface threaded through holes, so bottom edge can be lift up outside and complete window frame can be pulled downside so part #91 extended plate will come out from both holding slot and window will be removed completely to store in rear cargo area. That is make side window frame open for open air driving experience.

FIG. 48 is an enlarged sketch of part #91 and part #90 how side windows can be insert in it

As shown in FIG. 49 and 50 there is one more option and if both left and right-side windows want to remove completely, then as shown in FIG. 49 and 50. part #55 side window frame has part #93 right cylinder hinge installed above the top surface at side top corner of the hardtop cover which can be slide with rotation of attached assembly lock handle. this cylinder hinge pipe will hold part #91 hinge shaft which is installed at top right corner of part #55 window frame when side window frame need to at closed position, if side window frame need to be remove from the hardtop cover frame than part #93 assembly handle cart be rotate to slide cylinder hinge cover toward right so top corner hinge shaft will be open. then this right corner can be pull out little from the hardtop frame so complete frame can be pull right side to release fixed hinge shaft at left top edge corner above window frame. once complete frame will remove it can be store on floor of rear cargo area hardtop for open air driving experience.

if side window frame part #55 is fixed on frame of hardtop cover, window frame will press part #10 weather strip to give weather protection when it's at closed position, so when if need to open, 2 screws need to be removed from the inside at bottom edge of side window frame which is fixed with factory made top surface threaded through holes, so bottom edge can be lift up outside and complete window frame can be pulled downside so part #91 extended plate will come out from both holding slot and window will be removed completely to store in rear cargo area. That is make side window frame open for open air driving experience.

FIG. 50 is an enlarged sketch of part #92 and part #93 as to show how part #93 can be rotate so part #92 can be released.

In FIG. 51 shown This Invention also offer additional type of soft cover Showing Part #26 soft top cover additionally optional feature part made with flexible PVC or plastic kind of material either in clear vision, tinted or medium dark semi vision through material is additional feature to install above complete front and rear seating area top side when both left and right side freedom panels not installed above the vehicle top area for sun roof/moon roof kind of natural lighting driving experience and also for protection of weather inside of the both front and rear seating area with rubber sealing front edge part #27 Front slots clamp inserted and tight above top edge of front windshield and rubber sealing part #28 angle slot clamp insert to rear side top slot rearward facing slot of top surface above central cover and fit straight left to right side ends of the vehicle, left side and right side ends of soft cover has thick part #29 side rubber sealing hard material will stay down side straight both sides of vehicle top edge and it left and right side robber sealing rim will seal with top edge frame of both left and right side front and rear doors of the vehicle

In FIG. 52 Showing side view of Soft cover can see at top and front end has Part #27 front slot, right end shows part #28 angle slot and in middle showing side facing part #29 side rubber sealing.

as in FIG. 53 shown Part #87 Adjustable Hardtop support assembly attached as with Part #83, Part #82, part #84, and part #86 Top support has top surface plate can be attach or give vertical support to the hardtop cover from inside of the vehicle at many places where required vertical support as any of the option model made to open both side windows open for open air driving experience. below the top surface place threaded bolt is attached.

Part #83 is cylinder pipe threaded inside where and it has nerd finish for manually grip rotation and nut shape outer surface to use tool to tight with Part #86 threaded bottom end which can be insert with rotation of this internal treaded cylinder to adjust the height for installation of the hardtop cover above the vehicle. this cylinder pipe has 4 threaded holes at its bottom portion.

through this threaded hole screws can be tightening in inside of piston ring slot of part #84 piston ring holder, so this screw will let part #86-cylinder pipe to rotate but will stay fixed on part #84 Piston ring below the part #84 piston ring support one vertical plate has hole and its attached with 2 jaws as part #82 jaws in half circular shape. these 2 jaws can be opened and fixed above the part #15 roll cage pipe which installed on factory made vehicle and it can be tight with screw at its bottom end.

so, once this jaw is fixed above the roll cage pipe Part #83-cylinder pipe is in middle of part #84 Piston ring support and top support it can be rotate as required to adjust the height of top support and keep fixed as very large size fiber glass body installation above the vehicle.

In FIG. 54 shown complete view of as Option 4 with more clear drawings is a combination of selection on above mentioned options 1, and 3 to make Open convertible windows of rear cargo area hardtop when manufactured new or on existing factory-made hardtop to modify if it is as curved shape at top horizontal at sides and at rear, vertical cut at rear edge of both side windows and horizontal cut on both side windows at top edge must require modifying existing factory made hard top cover to install conversion kit

This is a similar option as mentioned with new clear drawing attached for clarity on initially applied options 1 and 3 to select which features users like to be installed if top horizontal corner is in curved shape.

FIG. 54 is complete closed Jeep type SUV with its part #3 and #4 Freedom panels is at closed position and both left and right-side windows is as closed position and rear glass window also shown as closed position with vertical rear edge of the both side windows has vertical extension of plate part #10 with weather strip to get pressure on weather strip when windows are at closed position, plus additional plate support is installed at inside edge of top of the both side windows when both side window will be at closed position, also Part #22 weather strip is installed at bottom edge of the rear glass windows as shown in FIG. 56. As shown in FIG. 54 both side windows are attached with removable hinges in 2 parts as mention with Part #98 fixed hinge portion which can be installed permanently with rear cargo area hardtop cover frame above the part #51 Hinge support below all side windows as top horizontal edge is in curved shapes. Part #99 removable hinge portion is attached permanently with both side window frames at top edge surface with screws.

Similar way Part #98 fixed hinges are attached with rear cargo area at bottom edge of the opening frame above top edge of the rear glass window. Part #99 removable hinge portion is attached with rear glass window at top edge and shown as all side window and rear glass window removable hinges are inserted above the shaft of the part #98 fixed hinge. if user want to remove the rear glass window, then it need to be opened upwards from its bottom edge and rotate up to 150 degrees till locking knob of the part #99 is open to slide out to the right side. So, it can be removed from the shaft of part #98

Part #95 Right angled power motor is installed at both rear top edge corner of the hardtop cover and it is attached with motor shaft with Part #96 vertical plate with both side windows at rear vertical edge surface to rotate window with power motor toward upside of top surface with 270 degrees rotation.

This hinge is specially designed as if users want to open the side windows and set above the hardtop cover either manually or with help of part #95 Power motor to set above the hardtop cover while driving the vehicle and no required to store and keep safe inside of rear cargo area or to store in garage.

But if some of the user do not want to set above the hardtop cover and want to remove it completely then it can be remove once it opened as lifted from bottom edge of the side window and lifted upwards till it's release knob comes up as open to slide out to remove the window. Part #96 rotation plate is designed as it can be removed from the shaft of the part #95 power motor. And it can be stored on the floor of the rear cargo area to feel open air driving experience if used do not want to set side windows above the hard top.

Now in FIG. 55 is showing complete opened Jeep type SUV showing complete view of as Option 4 to make as it is a combination of selection on above mentioned options 1 and 3 to make Open convertible windows of rear cargo area hardtop when manufactured new or on existing factory-made hardtop to modify if it is as curved shape at top horizontal at sides and at rear, as showing front seating area part #3 and #4 freedom panels are removed from the top cover. As showing in the figure both side windows of rear cargo area hardtop is opened and set above the hardtop

Showing vertical rear edge of the both side window frame has vertical extension of plate part #10 with weather strip to get pressure on weather strip when windows are at closed position, plus additional plate support is installed at inside edge of top of the both side window frame in horizontal position so when both side window will be at closed position its seal the window edges at top and rear vertical edges.

Front vertical edge has inside bended extension strip where rear door frame close with weather strip when door will have closed. Bottom portion of the window has extended material cover with inside right-angle plate above the top edge of the Main body frame of Jeep type SUV.

This is a similar option as mentioned new clear drawing attached for clarity on those option 1,3 and 4 to select which features users like to be installed if top horizontal corner is in curved shape.

Part #7 both left and right-side windows is opened from its bottom edge and lifted upwards to rotate 270 degrees as shown in FIG. 55 with part #95 power motor attached with Part #96 rotation plate attached with both side windows at rear vertical edge of the side windows. and part #11 rear glass window also shown as opened from its bottom edge and lifted about 150 degrees upwards, so its Part #99 removable hinge can be slide towards right-side so its cylinder of hinge will be separated front the shaft of the Part #98 fixed hinges and separated rear window glass from rear end of the hardtop cover frame.

In FIG. 56 showing part #11 rear glass window is separated from the rear frame of the hardtop cover frame of the vehicle. On which Part #99 removable hinges are shown at top edge of the glass window. Part #22 weather strip is installed at bottom edge of the rear glass windows as shown in FIG. 56 which can be sealed with rear cargo area door when rear door will be at closed position.

In FIG. 57 is enlarged view of the left side window frame of part #6 rear cargo area hardtop frame with part #7 left side window is at closed position as inserted both part #99 removable hinge cylinder is hold by part #98 fixed hinge shaft. Part #95 right angled power motor is installed above top rear end corner of the rear cargo area hardtop cover which relates to Part #96 rotation plate is installed permanently on outer vertical rear end of the window frame. Part #51 hinge support is installed above the curve at the top edge corner to make right angle to the Part #98 fixed hinge above it. part #10 extension plate is installed vertical at rear vertical inside edge of the rear cargo area hardtop fame and in horizontal position at inside edge at top of the window frame to seal with weather strip with rear vertical and top horizontal edge of the window frame when side window will be at closed position.

In FIG. 58 is showing combined assembly of Part #98 fixed hinge and part #99 removable hinge in position will look attached window at closed position. Part #98 fixed hinge will be fixed with the screws on top edge of the rear cargo area hardtop, this hinge is made as it has a horizontal piston shaft, this shaft has extra solid metal material in the center of the shaft in half cylinder shape like holding knob. There is a gap between holding knob and left side end of full cylinder from where shaft is coming out. As shown in FIG. 58 Part #99 is inserted above the shaft of part #98 and rotated downward so extended locking knob will be rotate inside the gap of it so window can be remove on any circumstances.

In FIG. 59 is showing combined assembly of Part #98 fixed hinge and part #99 removable hinge in position will look attached window at open position. Part #98 fixed hinge will be fixed with the screws on top edge of the rear cargo area hardtop, this hinge is made as it has a horizontal piston shaft, this shaft has extra solid metal material in the center of the shaft in half cylinder shape like holding knob. Now as shown in figure part #99 is as open window position up to 150 degrees rotation so locking knob is open to slide above the shaft to right side, so attached window can be slide to right as 2 of the part #99 removable hinges can be release from the shaft manually.

In FIG. 60 is enlarged view of only part #98 Fixed hinge as showing it has a shaft and above the shaft extended cylinder to hold the locking knob of removable hinge when it is required to close the window.

In FIG. 61 is enlarged view of only part #99 removable hinge has cylinder on bottom edge as shown in figure which can be cover up above the shaft of part #98 fixed hinge shaft passing through gap between wall of hinge and holding knob above the shaft. Once cylinder covered up complete shaft then its locking knob can be rotate downwards in between gap of extended holding knob and left side of the cylinder from where shaft is coming out. So, window can be closed, and it will not release until window will open upwards and rotated about 150 degrees.

Now in FIG. 62 is an enlarged view of part #51 hinge support which must require installing as support to the hinges on curved shape hardtop cover at top horizontal corner to make right angle to rotate hinges at 270 degrees when require opening and closing the windows.

In FIG. 63 is an enlarged view of part #95 right angled motor and part #96 rotation plate. FIG. 63 is showing as right-angle motor has powered motor attached with the right-angle gear box and rotation shaft of the motor is shown on the right side of the gear box which shaft should be in the center line with shaft of the both part #98 fixed hinges installed above the top edge corner of the hardtop cover. Part #96 rotation plate will be installed permanently on the both side window frames at the rear vertical edge as its top portion has exact gap to cover shaft of the Part #95 Power motor on the left side. So, when user want to install the complete window assembly side window assembly only can be inserted at 150 degrees from the vertical surface of the hardtop cover frame as mentioned for Part #99 removable hinge has locking knob should pass through the gap above the shaft of the part #98 manually towards power motor shaft. This 2 removable hinges and rotation plates top portion can be inserted all together only above the shaft This option is for only those users who do not want to set side windows above the top of the hardtop cover whole rear cargo area is opened.

If User do not want to remove side windows from the hardtop cover frame, then it can be open and close anytime by power switch which control the Part #95 right angle motor, then extra lock or some extended lock should be install permanently to lock the window above the top surface while it is opened and do not slide towards from while applying the break on the vehicle.

In FIG. 64 is showing complete opened Jeep type SUV showing complete view of as Option 4 is a combination of selection on above mentioned options 1,3 and 4 to make Open convertible windows of rear cargo area hardtop when manufactured new or on existing factory-made hard top to modify if it is as curved shape at top horizontal at sides and at rear, as showing front seating area part #3 and #4 freedom panels are removed from the top cover. As showing in the figure both side windows of rear cargo area hardtop is opened and removed from the rear cargo area hardtop cover

Showing vertical rear edge of the both side window frame has vertical extension of plate part #10 with weather strip to get pressure on weather strip when windows are at closed position, plus additional plate support is installed at inside edge of top of the both side window frame in horizontal position so when both side window will be at closed position its seal the window edges at top and rear vertical edges.

Front vertical edge has inside bended extension strip where rear door frame close with weather strip when door will have closed. Bottom portion of the window has extended material cover with inside right-angle plate above the top edge of the Main body frame of Jeep type SUV.

This is a similar option as mentioned new clear drawing attached for clarity on those option 1, 3 and 4 to select which features users like to be installed if top horizontal corner is in curved shape. Part #7 both left and right-side windows is opened from its bottom edge and lifted upwards to rotate 150 degrees to remove the part #99 removable hinge from part #98 fixed hinges and slid other direction so part #96 will also release from the shaft of the part #95 right angle motor. and part #11 rear glass window also shown as opened from its bottom edge and lifted about 150 degrees upwards, so its Part #99 removable hinge can be slide towards right-side so its cylinder of hinge will be separated from the shaft of the Part #98 fixed hinges and separated rear window glass from rear end of the hardtop cover frame. Part number 7 side windows show separately after removed from the hardtop cover as FIG. 66 is a left side window and FIG. 67 is a right-side window.

In FIG. 65 showing part #11 rear glass window is separated from the rear frame of the hardtop cover frame of the vehicle. On which Part #99 removable hinges are shown at top edge of the glass window. Part #22 weather strip is installed at bottom edge of the rear glass windows as shown in FIG. 56 which can be sealed with rear cargo area door when rear door will be at closed position.

In FIG. 66 is an enlarged image of Part #7 left side window shown separately after removed from the hardtop cover as it is a left side window on which as shown extended bent plate is towards front to get pressure from the weather strip on the vertical edge or the rear door.

In FIG. 67 is an enlarged image of Part #7 right-side window shown separately after removed from the hardtop cover as it is a right-side window on which as shown extended bent plate is towards front to get pressure from the weather strip on the vertical edge or the rear door.

In FIG. 68 is 5^{th} option to make as and shown as enlarged view or rear cargo area as modified showing closed rear cargo area. from the top, sides and rear area of the rear cargo area of the Jeep type sports utility vehicle and can be applied to make this system on any Pick Up-truck or any semi pick up has rear cargo area opened. In Jeep type Sports vehicle, Roll cage pipes in rear cargo area need to be removed from the ends behind the rear seat, so rear cargo area will not have any solid frame structure on the way as per this this 4th option need to make and works. Part #100 Central cover is a supplementary solid material frame will be installed above the factory made jeep type SUV as shown in FIG. 68 this central cover will cover above the rear seat of the vehicle, and the sides with it will have additional extended wall will resides on the top of the factory made frame structure, and it will also extended above the side frame of the rear wall of left and right-side factory made frame structure to raise partial heights on both sides so there will be ample height for Rear cargo area top cover can be inserted properly when it will be rotated and flip over to open the rear cargo area.

At front side this central cover covers to an additional supporting metal part #15 roll cage pipe behind the rear seat area and its bottom end is installed with factory made jeep structure to give vertical support to the factory-made roll cage pipes installed at top of the vehicle for safety, at top front surface there is a supporting slot to install part #3 and 4 top freedom panels

Part #103 weather strip supportive frame is installed in reverse C shape as it can be slide front or backwards to support Part #102 rear cargo area top cover at its front end to seal the top cover.

2 pieces of Part #104 release latch is connected to Part #103 weather strip supportive frame at both sides to move forward or backwards weather strip supportive frame by rotation when it is required to open or close the rear cargo area top cover.

Part #101 Extension plate made with solid material above rear door will have installed permanently is an extended supplementary part to install above the top surface of the rear door, so whenever rear door will open or closed it will move with the rear door

Part #102 rear cargo area Top cover for rear cargo area is a special designed hard top cover to install above the top surface of the rear cargo area. Which have front area is opened as C shape and its inside frame has opening on front side so vehicle has opening on rear cargo area when it is at closed position, its scaled with surface contact above the Part #103 weather strip supportive frame which will be slide backwards with rotation of the part #104 release latches. at rear side wall there will be part #107 Rear glass window will be attached with 2 hinges at top edge of the window. Part #106 Latch lock is installed on part #107 rear glass window to lock rear glass with part #102 rear cargo area top cover when its required to open the rear cargo area or even while driving the vehicle to secure rear cargo area.

Part #105 Convertible Hinge is a solid metal hinge connector is shown as installed in center above the top surface of the left side of the part #100 central cover as its top end of its T shape is attached with hinge cover which connected with left side edge of the part #102 rear cargo area top cover. Vertical cylindrical shaft of this hinge relates to circular solid metal plate at bottom is locked by 2 horizontal plate with screws upside attached with bottom surface of the part #100 in which vertical shaft of T part of the hinge pass through to rotate in horizontal 180 degrees rotation when its required to open or close part #102 rear cargo area top cover. This circular plate will be fastened by 2 horizontal plate both front and rear side to hold tight the circular plate in which T shape shaft is inserted to make solid support while rotating the part #102 rear cargo area top cover.

Top right corner arrow shows direction of part #102 can be lifted upward to rotate at 90 degrees when its required to open the rear cargo area

As shown in FIG. 69 how Part #102 rear cargo area top cover is lifted upwards in vertical direction to rotate 90 degrees lifted from right side top surface of the part #102 central cover left rear side and its showing as it in middle of its 180 degrees horizontal rotation to flip over the top cover. as its attached with Part #105 Convertible hinge top T shaft's horizontal which has vertical T shape shaft is attached inside with Pan #100 Central cover's left rear side surface at center of its left side edge.

Both Part #104 on both sides is rotated to pull part #103 Weather strip supportive plate towards front side of the vehicle to make open space on entire C shape area of the rear top end of the part #100 for clear path for 180 degrees rotation of Part #102 rear cargo area top cover.

At bottom of the image 69 shown arrow below the center of the part #105 Convertible Hinge is to show direction of 180 degrees rotation of part #102 rear cargo area top cover.

In FIG. 69 is shown as part #102 in middle of the rotation to complete the 180 degrees rotation and its will be inserted down with 90 degrees rotation down towards empty container space in rear cargo area in next FIG. 70

In FIG. 70 Showing as part #102 rear cargo area top cover is completely inserted in empty rear cargo area of the vehicle with completed rest of the horizontal rotation of the 180 degrees from as shown in FIG. 69 and then entire part #102 is rotated downwards in vertical rotation 90 degrees rotation to insert in clear cargo area.

First required vertical rotation of 90 degrees to open the part #102 rear cargo area to make entire top cover from horizontal to vertical position need to be lifted from right to left side, theft only it can be rotate 180 degrees horizontal rotation to change flip over the top of the hardtop toward bottom of the rear cargo area

then last step is to make rear cargo area top cover will be rotate in vertical rotation from left to right at 90 degrees to insert in rear cargo area.

This 3 steps rotation cart be possible manually only to open complete top, sides and rear cargo area opened as look like Pickup truck for passing and clear view in rear cargo area for open area driving experience, as on rest of all 5 options explained front two row seating area of the passenger both left and right-side top freedom top panels can be remove and stored inside of this flip over part #102 Rear cargo area top cover which inserted in rear cargo area.

Both of front and rear and both sides if it's a 2 door or 4 door vehicle side windows can be inserted inside of the door panels.

So, to make maximum opening of the Vehicle requirement this Convertible option on rear cargo area is only can be install in rear cargo area when Part #15 roll cage pipe will be removed, and it is supported by extension to the sides behind the rear seats from the existing Jeep type SUV as it is required for safety in case of the rollover.

This option of the invention offers all front and rear seating area passengers with 100% safety as roll cage pipes is removed only in rear cargo area to make fully convertible option to open entire top, side and rear walls to open and insert inside of rear cargo area with inbuilt mechanism to open and close the vehicle with hardtop anytime and at anyplace when it required to open or secure

What I claimed is:

1-21. (canceled)

22. A vehicle body with rigid hard top partition roof capable of driving with roof said both side freedom top panel keep secured to close body can be open and removable for open air driving experience comprising:
a pair of removable said as left and right-side freedom top panel as each of extended designed removable both side panels here mentioned as freedom top cover having bottom surfaces capable of setting on and connecting to respective top surfaces of respective ones and further enclosing with the front top surface of the slot above the central cover at top in corresponding at both right and left freedom panel front edges with top edge of the front windshield frame of the vehicle;
a screw in through hole in center and corners at bottom surface can be attach and tightened on factory installed horizontal roll cage pipes;
a pair of windows on both side of rear cargo area can be opened from its bottom edge and connected with hinges at top edge with openable hardtop convertible frame as all 3 windows can be closed or open with attached 270-degree rotation hinges which attached as to open windows to lift from bottom edge and open outside rotated to set parallel as both side windows can rest on both sides above top surface;
a rear glass window which attached with pivot hinges to open and set above both side windows on top of rear cargo area hardtop surface manually or with power motor to rotate upwards to make this type of mechanism to open vehicle in rear cargo area as claim 22.

23. A vehicle body with rigid hard top partition roof capable of driving with roof said left and right-side freedom panel to keep secured to close body or to remove for open air driving experience further comprising:
a set of hinge mechanism to make as both rear cargo area side windows can be close complete vehicle or able to open and rotate with 270-degree rotation hinges can be open from front vertical edge and rotate horizontally behind rear of the vehicle;
a top window can be opened from its front side horizontal edge and connected with hinges at rear side edge with rear cargo area openable hardtop frame to set parallel in vertical position outside behind the rear glass window of rear cargo area as claim 23.

24. A vehicle body with rigid bard top cover comprising:
a pair of both side windows to open from its front edge to open and rotate as connected with hinges at top rear edge corner with openable hardtop convertible frame as both left and right-side windows can be open from its front edge with 90-degree rotation outside towards back and can be insert in vertical position inside by pushing as it hang with channel attached inside under surface of rear cargo area hardtop and supported by channel at bottom edge corner of the both side windows to insert in properly with help of sliding knob inside of channel for additional support as required to as front edge of side window will stay out at both left and right-side window frames with support of bottom edge of frame;
a rear glass window frame can be installed permanently above the rear door of the vehicle; a top window above roar cargo area hardtop is mounted as to open from its front edge and rotate 90 degree downward inside to set parallel with rear glass window and both opened side windows inserted inside before rear window as claim 24.

25. A vehicle body with rigid hard top cover comprising:
a pair of both side windows of rear cargo area mounted as to open inside to rotate 90-degree rotation from its front edge a connected with hinges at top rear edge corner with openable hardtop convertible frame to rotate horizontally toward rear glass window inside of the rear cargo area to set vertically parallel with rear glass window;
a top window of rear cargo area mounted as to open born its front edge and rotate downward inside to set parallel with rear glass window;
a pair of solid metal angle mounted inside horizontally under both top corners and rear vertical corner as replacement of removed factory installed roll cage pipes both side for safety of vehicle body and goods in rear cargo area in case of rollover the vehicle from the road as claim 25.

26. A vehicle body with rigid hard top cover comprising:
a pair of both side windows mounted to open from its bottom edge and connected with rivet hinges at both top corners of the glass which attached inside of c shaped channel will make path to insert both side windows inside after it's opened under top surface of openable hardtop convertible frame above factory installed roll cage pipes;
a rear glass window mounted as to open from its bottom edge to rotate 90 degrees inside toward up to lock in hanging knob from top surface of the rear cargo area hardtop cover as claim 26.

27. A vehicle body with rigid hard top cover comprising:
a pair of side windows of rear cargo area mounted as to open and insert inside of the rear cargo area with i shape as alphabetic uppercase i shape hinges attached at the top edge of the side windows can open outside from its bottom edge to lift upward to inserted inside with i shape shaft can be slide in downside open c channels under the top of the rear cargo area top cover as claim 27.

28. A vehicle body with rigid hard top cover has curved round shape at both top sides and rear top corner comprising:
a pair of both side windows mounted with additional curved hinge support to mount hinges exactly fit with 90-degree fitting at top and side or rear surface required solid support for 270-degree rotation hinge above top side edge corner curved surface of rear cargo area top cover or on any model has rear cargo area top horizontal corner of sides and rear and rear edge vertical corner to make 270 degree rotation of the both side windows required to open outside from its bottom edge to set above the roof of the rear cargo area top cover;
a rear glass window mounted with curved hinge support to mount 270-degree rotation hinges to give solid 90-degree mounting support to open rear window from its bottom edge to open outside to rotate 270-degree rotation to set above the top cover of rear cargo area;
a pair of curved shape hinge support has under side curved surface as molded with fiberglass fabric and resin liquid mixed with hardener to mold as solid fiberglass to match exact surface of top curved surface of the rear cargo area hardtop with several countersink through holes to mount with through holes on rear cargo area hardtop to bolt form inside of the rear cargo area hardtop as claim 28.

29. A vehicle body with rigid hard top cover comprising:
pair of side windows of rear cargo area hardtop mounted as to open from its bottom edge with lifting and rotate outside to upside with support of hinges attached at top side edges as shown without hinge support as right-angle top corners to set above the top surface of the rear cargo area hardtop which can be hold by latch lock installed above the top surface;
a rear glass window mounted as to open inside from lifting its bottom edge and rotate with attached inside hinges towards up and set horizontally parallel with top surface of hardtop to hold with 2 latches to lock installed under rear cargo area top horizontal roll cage pipe as claim 29.

30. A vehicle body with rigid hard top cover comprising:
a pair of both side windows of the rear cargo area hardtop mounted as to open with lifting outside from
its bottom edge to rotate 270 degrees can be set above the top surface of rear cargo area hardtop cover;
a rear glass window mounted as to open outside with rotation about 90 degrees from its bottom edge to upward as to make glass in horizontal position to slide in with c shape channel at both side ends;
a ball point hinge mounted in center at top edge of the glass as ball point hinge can be slide inside of down side open hanging c shaped channel to get support;
a dual slot lock as alphabetic uppercase letter f to lock has 2 slots to hold the bottom edge of the glass after its inserted inside of rear cargo area to avoid brakeage or scratches as all 3 windows gather at one surface as claim 30.

31. A vehicle body with rigid hard top cover comprising:
a pair of both side windows and rear window of the rear cargo area mounted as to open outside to set either above the top surface of the rear cargo area to rotate at 270 degrees or with option to remove completely from the vehicle and store on safe place on the floor of the rear cargo area or in the garage to avoid rattling or possible damage;
a rear glass window mounted as to open with rotation to upside in horizontal position has right side end shaft can be lift one side from upside opened c shape hinge has opening to lift window shaft upward can release entire glass window assembly required to slide right side above c shape hinge to pull out left side shaft as inserted from fixed hinge cylinder will remove the complete rear glass assembly to store at safe place either in vehicle or in garage as in claim 33.

32. A vehicle body with rigid hard top cover comprising:
a pair of both side and rear windows mounted as to remove completely from the rear cargo area hardtop cover after opening from its bottom edge outside with removable vertical insert in slot mounted inside under hardtop cover to release both side windows and rear window from the frame with pulling downwards to open rear cargo area hardtop as claim 32.

33. A vehicle body with rigid bard top cover comprising:
a pair of both side windows are mounted as to open in rear cargo area has curved shape at top horizontal at top sides and rear on which user choose to open either side windows or rear glass windows in which side windows can be open and rotate upwards with 270 degrees rotation manually or by right angle power motor to rotate has removable slot in rotation plate at rear end so if user select to remove the windows form the vehicle with removable hinges on side windows installed at both sides top edge corners have molded fiberglass hinge support under it to make right angle support to rotate 270 degree outside with options as either to set above the top surface of the roof or as completely remove;
a pair of both side windows of rear cargo area mounted as option to remove from the rear cargo area of the vehicle with removable lunges at the top on side windows installed at both side top edge corners has hinge support under it to make right angle support to rotate 270 degree outside with extended weather protection supports on the frames inside a vertical rear and top horizontal edge with partition hinges as fixed with removable hinges after opening rear window outside and rotate to 150 degree with sliding both side windows towards front as at 150-degree rotation release slot can be open to slide on fixed hinges mounted on the rear cargo area hardtop cover as claim 33.

34. A vehicle body with rigid hard top cover comprising:
a rear cargo area top cover mounted as made single piece has both sides, rear and top surface area to open with lifting from one side in vertically 90 degrees rotation from right side to upward to rotate horizontally exact 180 degrees to flip over its top surface to downside to make as it can be inserted in rear cargo area floor with 90 degrees vertical rotation downward as to make fully opened rear cargo area from top closed position as entire downside c shaped rear cargo area hardtop cover can be flip over to insert in the floor as upside c shape with help of convertible hinge attached at top of the left side of the central cover in left side center as 34.
